(19) United States
(12) Patent Application Publication
(10) Pub. No.: US 2021/0407013 A1
(43) Pub. Date: Dec. 30, 2021

(54) SYSTEM AND METHOD FOR EXTENSIBLE DEVICE ASSESSMENT AND DYNAMIC POLICY CONFIGURATION

(71) Applicant: Blancco Technology Group Ip Oy, Joensuu (FI)

(72) Inventors: Donal O'Shaughnessy, Cork (IE); Paula Vermeulen, Cork (IE); William Lynn, Cork (IE); Donie Kelly, Cork (IE); William Fitzgerald, Cork (IE); Patrick Conway, Cork (IE); Charlie McGrory, Cork (IE)

(21) Appl. No.: 17/360,944

(22) Filed: Jun. 28, 2021

Related U.S. Application Data
(60) Provisional application No. 63/045,026, filed on Jun. 26, 2020.

(51) Int. Cl. G06Q 40/08; G06Q 30/00; G07C 5/00; G06F 8/61; B60R 16/04; B60R 16/023; G01S 19/48

(52) U.S. Cl. CPC G06Q 40/08; G06Q 30/012; G07C 5/008; H04N 1/00244; B60R 16/04; B60R 16/0238; G01S 19/48; G06F 8/61

(57) ABSTRACT

There are provided systems and methods for extensible device assessment and dynamic policy configuration, where a plurality of devices associated with a primary device owner can be covered in a dynamically adjustable insurance policy. In one embodiment, a primary device is tested and assessed for insurability, then additional related devices may be discovered devices through network connections established through communications interfaces with the primary device (as well as direct inputs from the device owner. Then once devices are discovered and more fully diagnosed for operational status, insurance/warranty options are assessed, and a list of devices, coverage options, and cost is provided to the device owner. As such, comprehensive insurance with known and manageable risk may be provided for a collection of devices, not all of which may be presented to an insurance agent in person.

### CROSS REFERENCE TO RELATED APPLICATIONS

This application claims full benefit of and priority to U.S. provisional patent application No. 63/045,026 filed Jun. 26, 2020 titled, “SYSTEM AND METHOD FOR EXTENSIBLE DEVICE ASSESSMENT AND DYNAMIC POLICY CONFIGURATION,” the disclosure of which is fully incorporated herein by reference for all purposes.

### FIELD OF THE INVENTION

The present invention relates to systems and methods for assessing and mitigating risk, and more particularly, to systems and methods for performing diagnostics on a mobile device and offering insurance based on the results of the diagnostics as well as identifying and offering insurance coverage for additional discoverable devices.

### BACKGROUND OF THE INVENTION

Today, the use of mobile devices is widespread, and increasing numbers of people utilize such devices in their daily lives. As used herein, the term “mobile device,” generally refers to any electronic device capable of being moved from place to place. Examples of such mobile devices include, but are not limited to cellular phones (also known more generally as “mobile phones”), smart watches, smart jewelry, portable digital assistants (PDAs), digital cameras, intelligent devices for the “Internet of Things” (or “IOT”), drone devices, mobile subscriber communication devices, tablet computers, media players, smart vehicles, laptop computers, and devices equipped with wireless intelligent agents installed such as Alexa, Google Voice, Siri, Cortana, and others. Additionally, IOT functions are also increasingly associated with electronic items considered less mobile but yet of significant value, such as so-called “smart” televisions, home electronics and sensors, refrigerators, washing machines and other appliances.

Consumers purchase millions of such devices every year, driven by the desire for enhanced features and functionality; replacement of worn, damaged, partially nonfunctional, or slower operating devices; or simply, just to obtain the latest product based on consumer loyalty or to show off new models to friends and acquaintances. Additionally, as more features and capabilities have been incorporated into newly-released devices, the cost of such devices has substantially increased, and in some cases, the cost of hand-held mobile devices can exceed laptops and even desktop computers. Thus, the trend to include more sophisticated “smart” performance in mobile and non-mobile devices corresponds to increased cost, and likewise, a need exists to provide insurance for a device presented for evaluation as well as for additional “discoverable” devices that may be associated with an authorized user or owner of the presented device. Further, as many existing insurance policies require in-person appearance and only cover new or recently-purchased devices, a need exists to provide (a) insurance or warranty coverage for devices that are not new or within a pre-determined time window of initial purchase (for instance, within a 30-day window), and (b) insurance or warranty coverage for devices that are not physically present with a person requesting insurance or warranty coverage in person. What is also needed is a system and method to decrease the likelihood of insurance fraud while presenting insurers and vendors the opportunity to safely provide more comprehensive device insurance coverage (and thus enhanced revenue opportunities with managed risk).

### SUMMARY OF THE INVENTION

As used herein, the term “device” can generally be an electronic device, a mobile device, a vehicle, a personal electronic device such as a smart watch or smart jewelry, or any device capable of being subject to a warranty or insurance policy. A primary device is a device initially presented for assessment, and secondary devices may be devices that are subsequently identified and considered for insurance or warranty coverage by the primary device owner. Further, as used herein, the term “mobile device,” “mobile electronic device,” or “device” generally refers to any electronic device capable of being moved from place to place, and has components (such as displays or screens) that can become faulty or damaged. A mobile device may be a stand-alone device such as a laptop computer, a desktop computer, a mobile subscriber communication device, a mobile phone, a personal digital assistant (PDA), a tablet computer, a digital camera, a video camera, a video game console, a media player, a global positioning system (GPS), Universal Serial Bus (USB) keys, mobile weapons, smart watches or jewelry, embedded electronics, and combinations thereof. A mobile electronic device may also be any electronic device integrated with another system or device. For example, a stereo, global positioning system, or other electronic device contained within a vehicle may be utilized in concert with the present invention. Software to implement methods of the present invention can be (1) installed on, or (2) downloaded onto a mobile device indirectly or directly at any time by an authorized user through the Internet, SMS text message, through wireless communication with an app provisioning store, or in any other suitable manner and at any suitable time for carrying out a method according to the invention. For example, the software may be installed on a device when purchased or downloaded after the device is purchased, or even after the device is damaged or otherwise becomes faulty. The mobile device may be insured against loss or theft, and systems and methods of the present invention may operate as part of, or in addition to, an insurance policy on the mobile device. Also as used herein, additional devices other than the primary device that are discoverable by or within the knowledge of the device owner may be referred to as “secondary devices,” and for example, but not by way of limitation, a secondary device may include one or more of a modem, a router, a smart appliance, an IoT device, a smart hub, a home alarm, a smart TV, a tablet, a streaming device, a desktop computer, a computer peripheral, a printer, a smart charger, a smart watch, smart personal devices, and a vehicle. An illustration in FIG. 6 further shows secondary devices of the present invention in the context of device discovery.

The present invention provides for a system and method for assessing an identified device (the “primary device”), and based on the assessment and discovery of related devices, providing insurance/warranty coverage for not only the identified device but also additional secondary devices. Such secondary devices are preferably owned or under the control of the primary device owner, but may be associated with other owners or parties, and such other owners or parties may choose to elect coverage for such devices. Also provided are systems and methods for extensible device assessment and dynamic policy configuration, wherein a collection of discovered/identified devices may be assessed in terms of insurability, and policy options presented to the primary device owner for selectively insuring none, some, or all of the discovered/identified devices. Also provided are systems and methods to allow updates of insurance coverage of a collection of identified/discovered devices over time, so that as devices are added or removed from ownership, become aged or outdated, or become subject to higher or lower insurance premiums, a comprehensive insurance/warranty policy may be dynamically changed as the factors that affect device policy coverages vary. For example, one of many dynamic factors that influence coverage cost and risk may include aging of the components, such as the battery, or mechanical buttons, switches, and jacks, off which become more likely to fail over time. Also affecting the dynamic factors that influence coverage are risk factors such as risk of loss based on a usage profile of a mobile device, the device's age, and known component failure history. Accordingly, either a sliding scale of coverage could be provided in such instances, wherein policy coverage limits may automatically be decreased or prorated over time, coverage caps imposed or adjusted, or the owner may elect to pay a higher deductible and/or premium to continue coverage for failures or casualties involving such device features. On the other hand, as the overall value of the insured device decreases over time due to aging features and/or wear and tear, the policy premium may be adjusted, coverage amounts may be adjusted, or any other combination of factors to make coverage affordable for the end user and profitable for the insurer. Further, in certain embodiments, claim caps may be adjusted periodically or based on analysis of device operating conditions or usage profiles, and such adjustments may be of particular interest to insurance/warranty providers when indications of high-risk environments, aging devices, or person with history of high number of claims are encountered. Further, aspects of the device diagnostics and assessment process may determine, before coverage is granted by an insurer/warranty provider, that a device has not been tampered with or reported lost and/or stolen.

Currently, a consumer wishing to insure an electronic device needs to apply for insurance when such device is new, and this is most commonly accomplished face-to-face in a retail setting such as a store. Because of insurers' desire to minimize the likelihood of fraudulent insurance claims (such as a person damaging a device then applying for insurance coverage after the fact), it may be difficult for consumers to obtain insurance coverage for electronic devices if such devices are not brand new or purchased within a short period of time from when the device was purchased from a retail outlet e.g. 30 days). On the other hand, while insurers desire the ability to sell more coverage for devices that are not newly obtained or are otherwise not currently seen by the vendors, they are frequently prevented from doing so to avoid the risk of loss from fraud.

Thus, technical benefits of the present invention are numerous; for example, embodiments of the present invention: make it easier for the customer to insure a broad range of devices; reduce fraud risk as a “known” or “lower risk” customer extends insurance to that customers' devices, particularly if that customer successfully completes diagnostic software of the customer's primary/secondary devices; reduce fraud risk by possibly extending diagnostic testing to other devices of the customer; increase revenue to the insurer by offering expanded coverage, and offers financial sales incentives for OEMs, maintenance facilities, warranty provision companies, and sales representatives; expand customer base by allowing primary insured customer to nominate additional “family and friends” to be added for insurance coverage, possibly providing financial incentives to do so; and provide a mechanism for a person to build a manifest of their owned devices more easily for insurance coverage in the event of a single item or a catastrophic loss (phone malfunction versus home burns down). Both insurance providers wishing to manage risks and optimize pricing point and consumers wishing to manage their insurance plan/coverage per device may benefit from aspects of the present invention, and markets for application may include OEMs, mobile network operators and warranty providers who may benefit from offering the insurance and making a commission and thereby increasing commissions through sales of additional insurance policies or riders.

In one embodiment, a method of the present invention comprises presenting a primary device associated with a device owner for assessment of insurability and/or warrantability, performing a diagnostic assessment of one or more features of the primary device, analyzing diagnostic assessment results regarding the primary device and storing the analyzed results in a database record associated with an identifier of the primary device, identifying one or more secondary devices associated with the device owner, respectively associating a unique secondary device identifier with each identified secondary device and storing the respective secondary device identifier and data regarding each respective identified secondary device in the database record, and for each identified secondary device, determine whether a diagnostic assessment should be performed, and if so, perform a diagnostic assessment of one or more device features of such identified secondary device, storing results of the diagnostic assessment in the database record associated with the respective secondary device identifier, also respectively analyzing the database record the primary device diagnostic assessment and each identified secondary device diagnostic assessment to determine options regarding insurance or warranty coverage; and presenting a list identifying the primary device and identified secondary devices along with respective options regarding insurance or warranty coverage to the primary owner. The primary device may comprise any kind of device appropriate for the assessment of the present invention, such as one of a smartphone, a mobile electronic device, a desktop computer, a tablet, or a smart vehicle. A secondary device may include one or more of a modem, a router, a smart appliance, an IoT (internet of things) device, a smart hub, a home alarm, a smart TV a tablet, a streaming device, a desktop computer, a computer peripheral, a printer, a smart charger, a smart watch, smart personal devices, and a vehicle. Also, the primary device may comprise a mobile smartphone, and methods of the present invention may further comprise installing an app on the primary device to perform the diagnostic assessment of one or more features of the primary device, and this may further comprise performing the diagnostic assessment of one or more features of the primary device in a remote server communicatively coupled to the primary device.

In one aspect, a secondary device of the present invention may comprise a mobile smartphone, and further comprising remotely installing an app on the secondary device to perform the diagnostic assessment of one or more features of the secondary device. Also, identifying one or more secondary devices associated with the device owner may further comprise one or more of: scanning a network that is communicatively coupled to the primary device and itemizing devices found included in the network; contacting a mobile network operator providing service to the primary device, and obtaining, from the mobile network operator, a list of devices in a group service plan with the primary device; manually entering, by the device owner, information regarding the one or more secondary devices; and sending an email or text message to an account accessible by a secondary device, and prompting a user of the secondary device to click on a link to provide information about the secondary device.

Further, performing a diagnostic assessment of one or more device features of an identified secondary device may include requesting the secondary device perform a self-test; and receiving results of the self-test, and aspects may further comprise prompting the device owner to select coverage options from presented coverage options for each of the primary device and secondary devices, and storing the selections in the database record. Additionally, presenting a list may further comprise computing and displaying to the device owner a total monthly premium for elected insurance or warranty options, and aspects of the present invention may further comprise analyzing one of the primary device and a secondary device and updating the database record to reflect an updated analysis. Also, implementations may include re-assessing respective options regarding insurance or warranty coverage and presenting an updated list of options to the primary user,

Options regarding insurance or warranty coverage options may further include cost of coverage, policy terms, premium payment amounts, claim caps for identified device feature repairs, device features included in coverage, device features excluded from coverage, and cost to obtain additional and/or enhanced coverage. Additionally, determining whether a diagnostic assessment should be performed may further comprise determining that a diagnostic assessment for a secondary device may be executed at a future time; and offering insurance or warranty coverage at an enhanced price until such assessment may be conducted. Additional aspects may further comprise installing a dynamic coverage evaluator app on one or more of the primary device and a secondary device, wherein the dynamic coverage evaluator app may remain active and execute in the background of such mobile device, wherein the dynamic coverage evaluator: accumulates a list of candidate devices that communicate with the mobile device over time; determines whether such candidate devices are already covered under a policy of the primary device owner; and if not, offers to add such uncovered devices to the device owner's policy either periodically or when prompted by the primary owner's use of the dynamic coverage evaluator. Further, an identifier of the primary device may include one or more of: a device's make, model, IMEI, phone number, device ID, device tag, account number, serial number, and a device fingerprint value.

In yet another aspect of the present invention, performing a diagnostic assessment of one of the primary device or a secondary device may include obtaining one or more of device identifying information, device orientation sensor status, battery status, branding labeling information, location information, memory information, device local radio operation, display status, housing status; device power up status, and audio status. In this arrangement, device orientation sensor status may include one or more of an operational status and a current value of a device's magnetometer, accelerometer, gyroscope, pressure sensor, or a sensor used by the device in obtaining its physical orientation. Further, battery status may include one or more of information regarding whether a device's battery is charged; whether the battery is capable of holding a charge; an estimated capacity comparison to original specification of a battery; a battery maximum and/or minimum level, and a current charging type. Additionally, location information may include one or more of locale indicators; GPS information; location data services information; connected wireless tower information; and visited Wi-Fi domains. Also, memory information may include one or more of: an average memory usage of a device; a maximum and minimum memory usage of a device; storage capacity of a device; storage used by a device; internal memory/storage of a device; and external memory card status and/or capacity of a device, and further, device local radio operation may include one or more of: operational status and information regarding whether a Wi-Fi connection is operational not, a device uptime figure, an amount of data sent or received through Wi-Fi; Bluetooth operational status; and NFC status. Additionally, display status information may include one or more test results regarding whether: a screen of the mobile device is cracked or not; a location of a crack on a screen of a device; a size and extent of a crack on a display of a mobile device; a current brightness level of a display; an indicator whether an LCD is functioning. And in another aspect, power up status includes one or more of whether a mobile device powers up in a predetermined period of time, and whether a power button of a mobile device is operational, and audio status may include whether a volume up button or down button works within predetermined ranges; whether a speaker is outputting an audio signal at an expected volume level, whether a microphone is receiving audio inputs with acceptable gain, whether a microphone is receiving audio inputs at predetermined frequencies, and whether a speaker of the mobile device is producing audio signals at desired amplitudes at a range of frequencies.

Aspects of the present invention may further comprise: identifying one or more secondary devices not directly associated with the device owner, and presenting an incentive for the device owner to contact an owner of the one or more secondary devices not directly associated with the device owner to propose insurance or warranty coverage. And in one embodiment, the database record is at least partially stored in a database server managed by a third-party insurance or warranty provider; and where in the database server is communicatively coupled to the primary device. One aspect also comprises dynamically adjusting a monthly premium amount based on usage profiles of the primary device and the secondary device, and in one implementation, the usage profiles include parameters related to risk of loss, damage, or aging of any of the primary device or secondary devices.

There is also presented a system of the present invention, the system comprising a primary device comprising mobile device, the primary device comprising: a processor in communication with a memory; a user interface in communication with the processor, the user interface including a touch-sensitive display and a data entry interface; a communications module in communication with the processor and configured to provide a communications interface to a third-party server, the third-party server further including a database, a server processor and a server memory; wherein one or more of the memory of the primary device or the server memory includes instructions that when respectively executed by the processor or the server processor perform the steps of: presenting a primary device associated with a device owner for assessment of insurability and/or warrantability; performing a diagnostic assessment of one or more features of a primary device presented by a device owner; analyzing diagnostic assessment results regarding the primary device and storing the analyzed results in a database record in the database, the database record associated with an identifier of the primary device; identifying one or more secondary devices associated with the device owner; respectively associating a unique secondary device identifier with each identified secondary device and storing the respective secondary device identifier and data regarding each respective identified secondary device in the database record; for each identified secondary device, determine whether a diagnostic assessment should be performed, and if so, perform a diagnostic assessment of one or more device features of such identified secondary device, storing results of the diagnostic assessment in the database record associated with the respective secondary device identifier; respectively analyzing the database record the primary device diagnostic assessment and each identified secondary device diagnostic assessment to determine options regarding insurance or warranty coverage; and presenting a list identifying the primary device and identified secondary devices along with respective options regarding insurance or warranty coverage to the primary owner.

Systems of the present invention may be configured to execute steps of the present invention whereby the primary device may comprise any kind of device appropriate for the assessment of the present invention, such as one of a smartphone, a mobile electronic device, a desktop computer, a tablet, or a smart vehicle. A secondary device may include one or more of a modem, a router, a smart appliance, an IoT (internet of things) device, a smart hub, a home alarm, a smart TV a tablet, a streaming device, a desktop computer, a computer peripheral, a printer, a smart charger, a smart watch, smart personal devices, and a vehicle. Also, the primary device may comprise a mobile smartphone, and methods of the present invention may further comprise installing an app on the primary device to perform the diagnostic assessment of one or more features of the primary device, and this may further comprise performing the diagnostic assessment of one or more features of the primary device in a remote server communicatively coupled to the primary device.

Systems of the present invention may be configured to execute steps of the present invention whereby in one aspect, a secondary device of the present invention may comprise a mobile smartphone, and further comprising remotely installing an app on the secondary device to perform the diagnostic assessment of one or more features of the secondary device. Also, identifying one or more secondary devices associated with the device owner may further comprise one or more of: scanning a network that is communicatively coupled to the primary device and itemizing devices found included in the network; contacting a mobile network operator providing service to the primary device, and obtaining, from the mobile network operator, a list of devices in a group service plan with the primary device; manually entering, by the device owner, information regarding the one or more secondary devices; and sending an email or text message to an account accessible by a secondary device, and prompting a user of the secondary device to click on a link to provide information about the secondary device.

Further, systems of the present invention may be configured to execute steps of the present invention whereby performing a diagnostic assessment of one or more device features of an identified secondary device may include requesting the secondary device perform a self-test; and receiving results of the self-test, and aspects may further comprise prompting the device owner to select coverage options from presented coverage options for each of the primary device and secondary devices, and storing the selections in the database record. Additionally, presenting a list may further comprise computing and displaying to the device owner a total monthly premium for elected insurance or warranty options, and aspects of the present invention may further comprise analyzing one of the primary device and a secondary device and updating the database record to reflect an updated analysis. Also, implementations may include re-assessing respective options regarding insurance or warranty coverage and presenting an updated list of options to the primary user,

In various system aspects of the present invention, options regarding insurance or warranty coverage options may further include cost of coverage, policy terms, premium payment amounts, claim caps for identified device feature repairs, device features included in coverage, device features excluded from coverage, and cost to obtain additional and/or enhanced coverage. Additionally, determining whether a diagnostic assessment should be performed may further comprise determining that a diagnostic assessment for a secondary device may be executed at a future time; and offering insurance or warranty coverage at an enhanced price until such assessment may be conducted. Additional aspects may further comprise installing a dynamic coverage evaluator app on one or more of the primary device and a secondary device, wherein the dynamic coverage evaluator app may remain active and execute in the background of such mobile device, wherein the dynamic coverage evaluator: accumulates a list of candidate devices that communicate with the mobile device over time; determines whether such candidate devices are already covered under a policy of the primary device owner; and if not, offers to add such uncovered devices to the device owner's policy either periodically or when prompted by the primary owner's use of the dynamic coverage evaluator. Further, an identifier of the primary device may include one or more of: a device's make, model, IMEI, phone number, device ID, device tag, account number, serial number, and a device fingerprint value.

In yet another aspect of a system of the present invention, performing a diagnostic assessment of one of the primary device or a secondary device may include obtaining one or more of device identifying information, device orientation sensor status, battery status, branding labeling information, location information, memory information, device local radio operation, display status, housing status; device power up status, and audio status. In this arrangement, device orientation sensor status may include one or more of an operational status and a current value of a device's magnetometer, accelerometer, gyroscope, pressure sensor, or a sensor used by the device in obtaining its physical orientation. Further, battery status may include one or more of information regarding whether a device's battery is charged; whether the battery is capable of holding a charge; an estimated capacity comparison to original specification of a battery; a battery maximum and/or minimum level, and a current charging type. Additionally, location information may include one or more of locale indicators; GPS information; location data services information; connected wireless tower information; and visited Wi-Fi domains. Also, memory information may include one or more of: an average memory usage of a device; a maximum and minimum memory usage of a device; storage capacity of a device; storage used by a device; internal memory/storage of a device; and external memory card status and/or capacity of a device, and further, device local radio operation may include one or more of: operational status and information regarding whether a Wi-Fi connection is operational not, a device uptime figure, an amount of data sent or received through Wi-Fi; Bluetooth operational status; and NFC status. Additionally, display status information may include one or more test results regarding whether: a screen of the mobile device is cracked or not; a location of a crack on a screen of a device; a size and extent of a crack on a display of a mobile device; a current brightness level of a display; an indicator whether an LCD is functioning. And in another aspect, power up status includes one or more of whether a mobile device powers up in a predetermined period of time, and whether a power button of a mobile device is operational, and audio status may include whether a volume up button or down button works within predetermined ranges; whether a speaker is outputting an audio signal at an expected volume level, whether a microphone is receiving audio inputs with acceptable gain, whether a microphone is receiving audio inputs at predetermined frequencies, and whether a speaker of the mobile device is producing audio signals at desired amplitudes at a range of frequencies.

Aspects of systems of the present invention may further comprise: identifying one or more secondary devices not directly associated with the device owner, and presenting an incentive for the device owner to contact an owner of the one or more secondary devices not directly associated with the device owner to propose insurance or warranty coverage. And in one embodiment, the database record is at least partially stored in a database server managed by a third-party insurance or warranty provider; and where in the database server is communicatively coupled to the primary device. One aspect also comprises dynamically adjusting a monthly premium amount based on usage profiles of the primary device and the secondary device, and in one implementation, the usage profiles include parameters related to risk of loss, damage, or aging of any of the primary device or secondary devices.

In yet another embodiment, a method of the present invention comprises presenting a primary device associated with a device owner for assessment of insurability and/or warrantability; performing a diagnostic assessment of one or more features of the primary device; analyzing diagnostic assessment results regarding the primary device through use of one or more of: an app installed on the primary device; a software development kit installed via an app previously installed on the primary device; and a web-based interface through visiting, by the primary device, a web page which is configured to communicate with the primary device to initiate one or more diagnostic tests on the primary device; and analyze results of the diagnostic tests and storing the analyzed results in a database record associated with an identifier of the primary device. Further, aspects further comprise analyzing the database record the primary device diagnostic assessment to determine options regarding insurance or warranty coverage; and presenting options regarding insurance or warranty coverage of the primary device to the primary owner. Additionally in one aspect, the primary device is one of a smartphone, a mobile electronic device, a desktop computer, a tablet, or a smart vehicle.

The primary device may comprise a mobile smartphone, and methods further comprise installing an app on the primary device to perform the diagnostic assessment of one or more features of the primary device, and may further comprise performing the diagnostic assessment of one or more features of the primary device in a remote server communicatively coupled to the primary device.

In various embodiments, presenting options further comprises computing and displaying to the device owner a total monthly premium for elected insurance or warranty options. Aspects may further comprise re-assessing respective options regarding insurance or warranty coverage and presenting an updated options to the primary user. Also, options regarding insurance or warranty coverage options may additionally include cost of coverage, policy terms, premium payment amounts, claim caps for identified device feature repairs, device features included in coverage, device features excluded from coverage, and cost to obtain additional and/or enhanced coverage.

In additional embodiments, methods of the present invention may further comprise installing a dynamic coverage evaluator app on the primary device, wherein the dynamic coverage evaluator app may remain active and execute in the background of such mobile device, wherein the dynamic coverage evaluator: accumulates a list of candidate devices that communicate with the mobile device over time; determines whether such candidate devices are already covered under a policy of the primary device owner; and if not, offers to add such uncovered devices to the device owner's policy either periodically or when prompted by the primary owner's use of the dynamic coverage evaluator. In one implementation, an identifier of the primary device may include one or more of: a device's make, model, IMEI, phone number, device ID, device tag, account number, serial number, and a device fingerprint value. Further, performing a diagnostic assessment of one of the primary device may further include obtaining one or more of device identifying information, device orientation sensor status, battery status, branding labeling information, location information, memory information, device local radio operation, display status, housing status; device power up status, and audio status.

In yet another embodiment, device orientation sensor status may include one or more of an operational status and a current value of a device's magnetometer, accelerometer, gyroscope, pressure sensor, or a sensor used by the device in obtaining its physical orientation, and in another aspect, battery status may include one or more of information regarding whether a device's battery is charged; whether the battery is capable of holding a charge; an estimated capacity comparison to original specification of a battery; a battery maximum and/or minimum level, and a current charging type. Location information may include one or more of locale indicators; GPS information; location data services information; connected wireless tower information; and visited Wi-Fi domains, and in yet another implementation, memory information includes one or more of: an average memory usage of a device; a maximum and minimum memory usage of a device; storage capacity of a device; storage used by a device; internal memory/storage of a device; and external memory card status and/or capacity of a device. Also, device local radio operation may include one or more of: operational status and information regarding whether a Wi-Fi connection is operational not, a device uptime figure, an amount of data sent or received through Wi-Fi; Bluetooth operational status; and NFC status, and in yet another implementation, display status information includes one or more test results regarding whether: a screen of the mobile device is cracked or not; a location of a crack on a screen of a device; a size and extent of a crack on a display of a mobile device; a current brightness level of a display; an indicator whether an LCD is functioning. Power up status may include one or more of whether a mobile device powers up in a predetermined period of time, and whether a power button of a mobile device is operational, and audio status may include whether a volume up button or down button works within predetermined ranges; whether a speaker is outputting an audio signal at an expected volume level, whether a microphone is receiving audio inputs with acceptable gain, whether a microphone is receiving audio inputs at predetermined frequencies, and whether a speaker of the mobile device is producing audio signals at desired amplitudes at a range of frequencies.

Aspects of the present invention may further comprise identifying one or more secondary devices not directly associated with the device owner, and presenting an incentive for the device owner to contact an owner of the one or more secondary devices not directly associated with the device owner to propose insurance or warranty coverage. Further, the database record is at least partially stored in a database server managed by a third-party insurance or warranty provider; and where in the database server is communicatively coupled to the primary device, and aspects may further comprise dynamically adjusting a monthly premium amount based on usage profiles of the primary device. Usage profiles, in one implementation, include parameters related to risk of loss, damage, or aging of any of the primary device or secondary devices.

### BRIEF DESCRIPTION OF THE DRAWINGS

A more complete understanding of the present invention may be derived by referring to the detailed description and claims when considered in connection with the following illustrative figures.

FIG. 1 illustrates a conceptual block diagram of an embodiment of a system of the present invention.

FIG. 2 depicts a block diagram of a system embodiment of the present invention illustrating a Mobile Network Operator in Secondary Device Identification.

FIG. 3 shows exemplary flow diagram of steps used to implement aspects of the present invention.

FIG. 4 shows a continued exemplary flow diagram of steps used to implement aspects of the present invention.

FIG. 5 illustrates an alternate system and flow diagram of the present invention.

FIG. 6 shows potential secondary devices discovered by aspects of the present invention.

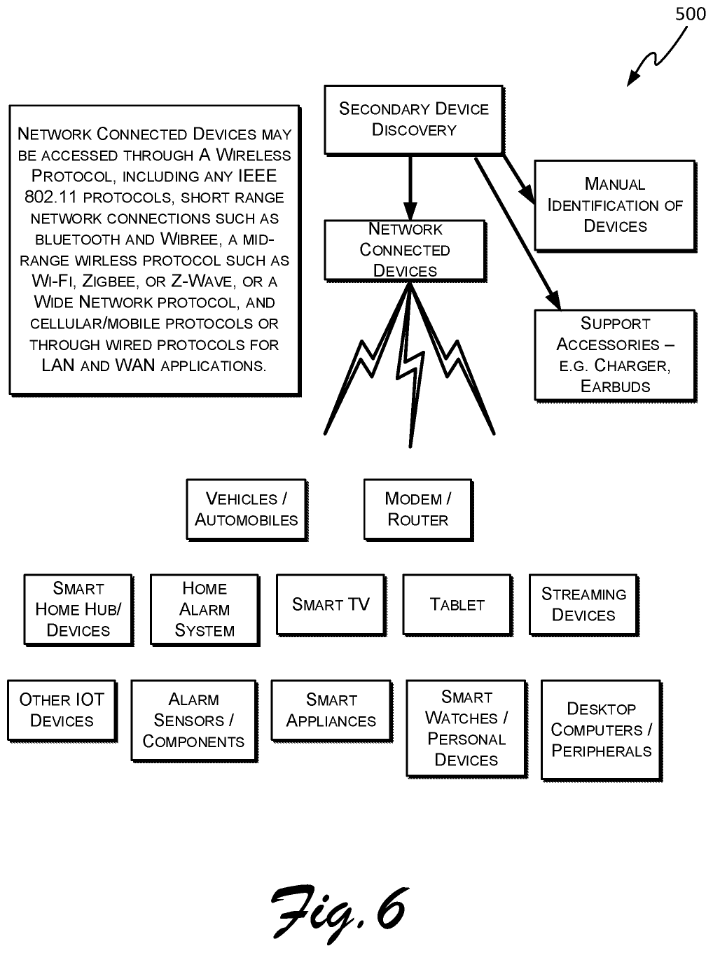

FIG. 7 illustrates an alternate block diagram of a system embodiment of the present invention.

### DETAILED DESCRIPTION

According to one aspect, the present method allows for an existing policy holder to run diagnostics on a device (e.g. a phone or tablet) that they would like to insure. This ensures that the policy holder gets the best deal based on the condition of the device. If the condition is not adequate, the primary policy holder may not be able to insure that specific device, or may offer a pricing or coverage compromise, or the device owner may still be given the option to test other devices that they would like to insure or cover under warranty. The insurer/warranty provision service can configure these diagnostic tests in order to be sure that the important aspects of the device condition are tested and recorded (resulting in a reduction in risk). In-depth results and details of the diagnostic tests can be viewed on an insurance management portal.

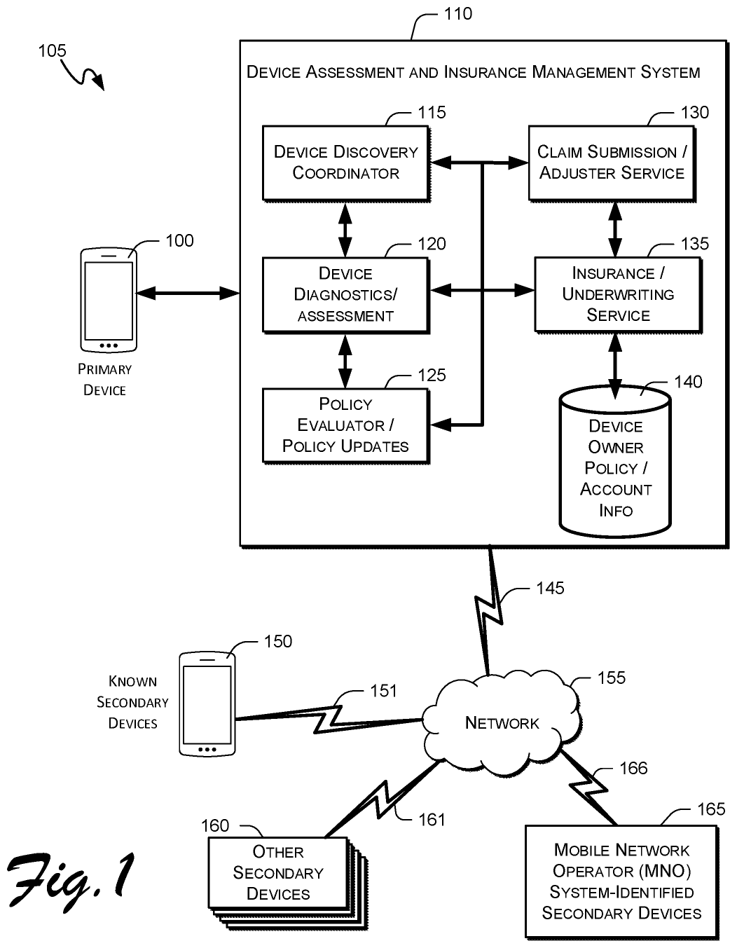

For example, FIG. 1 illustrates a high-level overview of a system embodiment 105 of the present invention. A primary device 100, which may comprise a mobile telephony device, is communicatively interfaced to a device assessment and insurance management system (DAIMS) 110, which is preferably implemented through hardware and software in both the device 100 and a remote third-party server, or may be independently implemented on the device 100 or the remote server. The DAIMS 110 includes a Device Discovery Coordinator 115, which assists in identifying secondary devices for possible consideration of insurance/warranty coverage. Also included is a device diagnostics and assessment function 120, where individual device features may be diagnosed and assessed to determine functional status for insurance purposes (e.g., whether any defects can be found with device orientation sensors; device battery; location/geolocation determination (e.g. GPS); memory status; device local radio operation; display status; housing status; device power up status, and audio component status). The diagnostics may be installed and executed via an app on the primary device 100, on a secondary device (e.g. 150, 160, 165), remotely executed by a server communicatively coupled to the primary device 100 or secondary devices, or by a combination thereof.

A policy evaluator and policy updates function 125 is provided to calculate whether the primary device 100 or any secondary device is insurable or coverable via warranty, and if so, the limits and costs for such respective coverage. In one embodiment, discussed in more detail below, a list of devices is presented along with options for inputs by the owner of the primary device 100, allowing the selection of a desired coverage configuration based on test status of the devices. As mentioned previously, conventional insurance or warranty providers avoid providing coverage for devices not presented to the insurance/warranty agent, but with embodiments of the present invention discussed more fully below, the insurer may provide coverage options at known and more quantifiable risk thresholds. If primary and secondary devices are re-assessed, as may be desirable periodically, the policy evaluator may dynamically scale coverage options and pricing accordingly, and allow the device owner to make selections appropriately based on the updated presentation of coverage. Also shown is a claim submission and adjuster service 130, which integrates an interface for the covered devices (such as the primary device and covered secondary devices) with the insurance/underwriting service 135, to allow more automated submission and processing of device claims. Finally, the insurance/underwriting service 135 maintains a remote server with an included database 140, which may contain information about the device owner's account, information about the primary device, and information concerning secondary devices identified during the discovery process 115. Thus, the DAIMS 110 may be integrated within an app installed in the primary device 100, executed remotely on a server associated with an account of the device owner (e.g. at an insurance agency 135), through a browser link to the server, or, in preferred embodiments, through a combination of the mobile app and remote server.

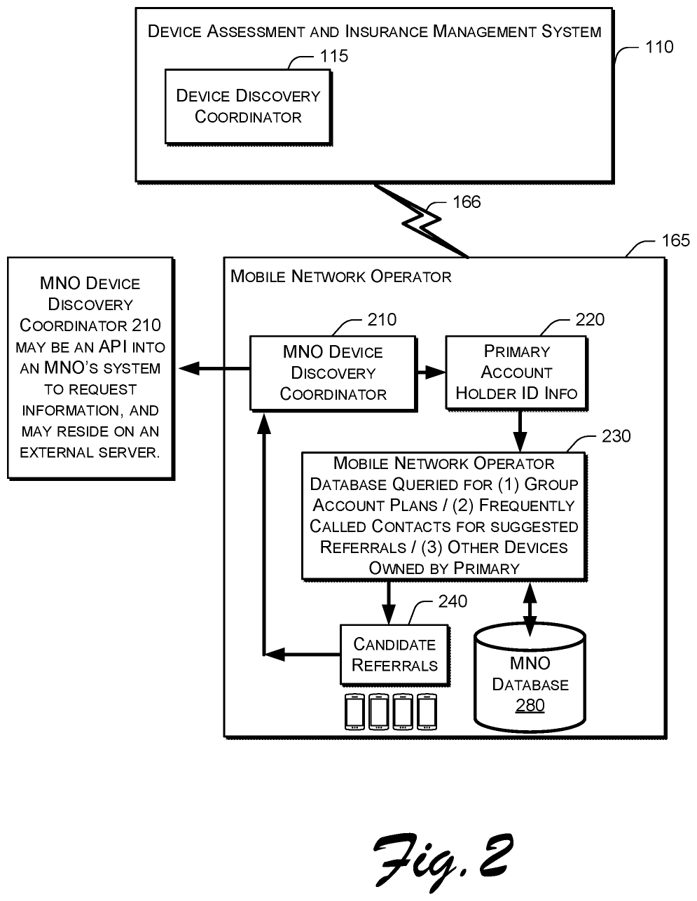

Regarding the Device Discovery Coordinator, 115, and to summarize more generally, embodiments of the present invention provide several ways of adding devices to the existing policy conveniently. FIG. 1 shows a communicative coupling 145, to a generalized network 155, and the coupling may comprise a wired connection and/or a wireless protocol. Known secondary devices 150 may be directly identified by the device owner for possible analysis and inclusion in an insurance policy. Further, the device owner/potential policy holder may utilize the Device Discovery Coordinator 115 to run a scan in order to identify other connected devices 160 that are visible through connection 161 to the network 155. These secondary devices 160 include be any electronic devices that are communicatively coupled to the primary device 100 that are desired to be insured by the company, such as smart watches, TV's, routers, printers, Bluetooth products & accessories, game consoles, other phones, tablets etc. Further, and as more fully explained in regards to FIG. 2, the Device Discovery Coordinator 115 may interface 166 to a Mobile Network Operator (MNO) to obtain a list of system-identified secondary devices 165, such as those for which the primary device's owner may have obtained mobile service—these may commonly occur in friend and family plans or through shared wireless accounts. As FIG. 2 illustrates, a MNO Device Discovery Coordinator 210 (such as an Application Programming Interface or API) may provide interface with the MNO to accept the Primary Account Holder's (or Primary Device Owner's) identification information 220, then may utilize a lookup function from the MNO's database 280 to identify 230 group account plans, frequently called contacts for suggested referrals, or other devices owned by the primary device owner that are visible to the MNO. A candidate device list is produced 240, and through the MNO Device Discovery Coordinator 210, transmitted 166 to the DAIMS 110 of FIG. 1 (as shown simplified in FIG. 2), further augmenting the list of secondary devices for possible inclusion into insurance or warranty coverage. Ultimately, the devices that device owners choose to insure can be selected as they are and added to a new quote.

Thus, the present invention allows for extending insurance coverage: once the primary policy holder has accepted the quoted premium and added it to their bill, they have the option of insuring more devices. Further, for secondary devices that have not yet had diagnostics run, device owners can be offered coverage at an initial higher price but then if the primary device owner conducts the diagnostics and assessment on such devices, the insurer can offer a different price after receiving the results of the diagnostics, which may be substantially lower based on risk reduction. Also, if the results of diagnostics indicate that one or more components of the device are damaged (such as a cracked display being detected) a modified insurance option may be offered at a lower price to provide coverage only for the components of the device that are in acceptable working order, or a reduced replacement value may be offered if the damaged device is lost altogether. Further, with optional permissions granted by the device owner, diagnostics may be automatically installed on secondary devices and run at a future time when such execution is most desirable (such as in the background in a period of standby status, or when a current user of such device is prompted to begin a test (such as a mirror-based display test).

Without aspects of the present invention, candidate items for insurance may not be allowed to be covered by insurance or warranties if they are not presented in person; and without aspects of the present invention, it may be practically impossible to determine an accurate list of other devices that a primary account holder wishes to ensure, and to assess the operational condition of such devices for insurance, warranty, and fraud mitigation purposes.

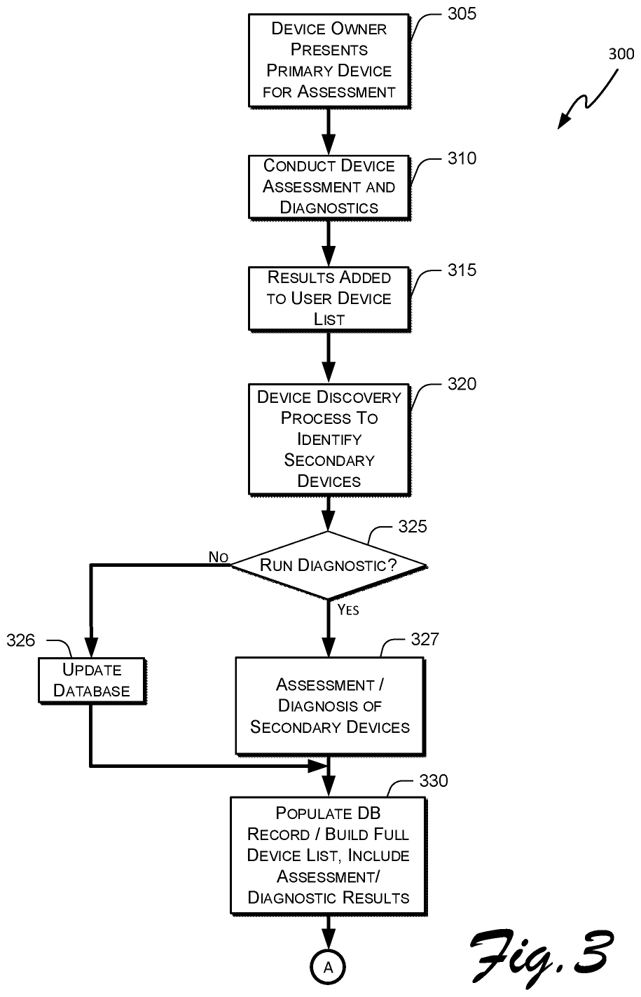

A method of the present invention is illustrated in the flow diagram 300 of FIG. 3. A device owner presents 305 a primary device associated with the owner for assessment of insurability and/or warrantability; during this process sufficient information is provided by the device owner to uniquely identify the primary device, such as a phone number associated with the primary device, an IMEI, or any other unique identification; and an app may be installed on the primary device if the device is a mobile device. A diagnostic assessment of one or more features of the primary device is then performed 310 and the diagnostic may be conducted by the installed app, by a diagnostic run through a web-based interface to a remote server, or through any combination of the two approaches. Put another way, if the primary device is a mobile smartphone, then analysis may further include installing an app on the primary device to perform the diagnostic assessment of one or more features of the primary device; or, alternatively or in combination, to perform the assessment of the primary device in a remote server communicatively coupled to the primary device. The diagnostic results are analyzed and the results regarding the primary device are stored 315 to a database record associated with an identifier of the primary device (such as in a device list record entry for the mobile device). In one embodiment, the database record is at least partially stored in a database server managed by a third-party insurance or warranty provider and the database server is communicatively coupled to the primary device. In various embodiments, an identifier of the primary device may include one or more of: a device's make, model, IMEI, phone number, device ID, device tag, account number, serial number, and a unique device fingerprint value. In one embodiment, the process continues with identifying 320 one or more secondary devices associated with the device owner; appropriate user permissions may be requested of the device owner to grant access to information about the discovered secondary devices. While the discovery step 320 may be completely automatic in some embodiments, the device owner may also manually submit information about secondary devices that are desired for insurance coverage. Discovery step 320 may include identifying one or more secondary devices associated with the device owner further comprising one or more of: scanning a network that is communicatively coupled to the primary device and itemizing devices found included in the network; contacting a mobile network operator providing service to the primary device, and obtaining, from the mobile network operator, a list of devices in a group service plan with the primary device; manually entering, by the device owner, information regarding the one or more secondary devices; and sending an email or text message to an account accessible by a secondary device, and prompting a user of the secondary device to click on a link to provide information about the secondary device. In one embodiment, the discovery step 320 includes scanning by the primary device a local area network (LAN) that the device is connected to in order to obtain a list of IP addresses on the network and querying each IP addresses for a hostname and/or a media access control (MAC) address, for example. Further, during discovery step 320, a unique secondary device identifier is respectively associated with each identified secondary device, and the respective secondary device identifier and data regarding each respective identified secondary device is stored in the database record.

In step 325 for each identified secondary device, a determination is made whether a diagnostic assessment of each respective secondary should be performed. In some cases, secondary devices such as mobile devices lend themselves to comprehensive diagnostic techniques, but other types of secondary devices such as simple IoT devices may not be possible to remotely or completely diagnose, in which event the information and limitations on diagnostics are recorded 326 in the database record for the respective device. Additionally, determining whether a diagnostic assessment should be performed for a secondary device may further comprises determining that a diagnostic assessment for the secondary device may be executed at a future time; and offering insurance or warranty coverage at an enhanced price until such assessment may be conducted. If diagnosis is to be conducted for a particular secondary device, then a diagnostic assessment is performed 327 of one or more device features of such identified secondary device. In one embodiment, if the secondary device is a mobile smartphone, the process further includes remotely installing an app on the secondary device to perform the diagnostic assessment of one or more features of the secondary device. In yet another aspect, performing a diagnostic assessment of one or more device features of an identified secondary device includes requesting the secondary device perform a self-test; and receiving results of the self-test. Whether or not tests are conducted, results of the diagnostic assessment (or limited assessment) are stored in the database record associated with the respective secondary device identifier; the database record including the secondary devices associated with the primary device is updated 330, and includes any assessment and diagnostic results. In one embodiment, a full device list (FDL) stored in the database may include one or more of device description information, ID info such as assigned phone number, assigned hostname, assigned MAC address, model/serial number, IMEI of the referenced device, owner and authorized users of a referenced device, whether device is mobile, identification of a Mobile Network Operator, location of device, diagnostic tests that were executed and results of diagnostics, functional relationship to primary device (e.g. mobile phone on family plan), insurance/warranty information (e.g. policy/coverage-related information), and referral source/payment share arrangement for payment of referral incentive.

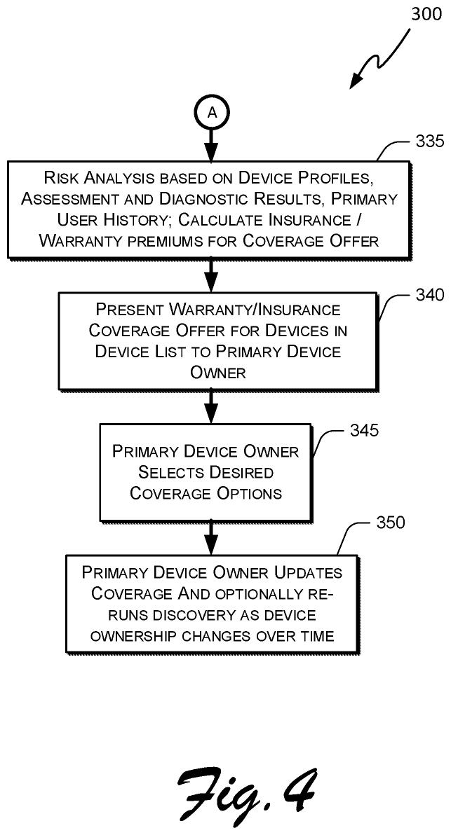

The process 300 continues on FIG. 4. Once the database is completely updated, then the database record is analyzed regarding the primary device diagnostic assessment and each identified secondary device diagnostic assessment to determine options regarding insurance or warranty coverage 335; during this process risk assessment/analysis is performed based upon the condition and type of each device listed in the database, as well as cost considerations and policy limitations and exclusions. Risk analysis may be further based on device usage profiles, assessment and diagnostic results, device owner account history, and other factors as discussed herein. Additionally, a calculation is made to prepare offers for insurance/warranty premiums and coverage conditions and limitations for each of the items in the full device list. Then, a list is presented 340 identifying the primary device and identified secondary devices along with respective options regarding insurance or warranty coverage for each device (as well as the package) to the primary owner. Presenting the list may further include computing and displaying to the device owner a total monthly premium for elected insurance or warranty options. For example, options regarding insurance or warranty coverage options may include cost of coverage, policy terms, premium payment amounts, claim caps for identified device feature repairs, device features included in coverage, device features excluded from coverage, and cost to obtain additional and/or enhanced coverage. The primary device owner may then be prompted 345 to select coverage options from presented coverage options for each of the primary device and secondary devices, and the selections are updated and stored in the database record. The insurer/warranty provider may then access the database record, create an invoice and bill the primary device owner for the policy as configured. However, over time, the needs of the device owner may change, as does the owner's associated devices (as new ones are added, aged/failed ones are discarded, etc.) As such, the primary device owner may access the full device list and update coverage options 350 as desired over time, and in one embodiment, the primary device owner may re-assess respective options regarding insurance or warranty coverage and review an updated list of options for selection of adjusted policy coverage. In an alternate embodiment, the discovery process is re-run on a periodic basis that may be adjustable by the primary device owner. The discovery process may run completely independently of the primary device owner's input and if no additional candidate devices are found, in one embodiment, the owner may not be contacted thus minimizing interaction with the primary device owner. Additional aspects are described as follows.

Yet another implementation includes installing a dynamic coverage evaluator app on one or more of the primary device and a secondary device, wherein the dynamic coverage evaluator app may remain active and execute in the background of such mobile device, wherein the dynamic coverage evaluator accumulates a list of candidate devices that communicate with the mobile device over time, determines whether such candidate devices are already covered under a policy of the primary device owner, and if not, offers to add such uncovered devices to the device owner's policy either periodically or when prompted by the primary owner's use of the dynamic coverage evaluator. In this way, automatic updates may be performed to provide the most relevant and meaningful coverage options for a primary device owner to consider. Further, the device owner's policy may be periodically cleared of devices that have not been in communication with the primary device within a pre-determined period, e.g. a one-year window. In one embodiment, the device owner's policy is cleared of devices whose assigned MAC address has not been identified on the local area network (LAN) by the primary device within a pre-determined period. In yet another aspect, a monthly premium amount may be dynamically adjusted based on usage profiles of the primary device and the secondary device. The usage profiles include parameters related to risk of loss, damage, or aging of any of the primary device or secondary devices.

In various implementations, performing a diagnostic assessment of one of the primary device or a secondary device includes obtaining one or more of device identifying information, device orientation sensor status, battery status, branding labeling information, location information, memory information, device local radio operation, display status, housing status; device power up status, and audio status. For example, the device orientation sensor status may include one or more of an operational status and a current value of a device's magnetometer, accelerometer, gyroscope, pressure sensor, or a sensor used by the device in obtaining its physical orientation. The battery status may include, for example, one or more of information regarding whether a device's battery is charged; whether the battery is capable of holding a charge; an estimated capacity comparison to original specification of a battery; a battery maximum and/or minimum level, and a current charging type. Location information may include one or more of locale indicators; GPS information; location data services information; connected wireless tower information; and visited Wi-Fi domains. Memory information may include one or more of: an average memory usage of a device; a maximum and minimum memory usage of a device; storage capacity of a device; storage used by a device; internal memory/storage of a device; and external memory card status and/or capacity of a device. Further, device local radio operation may include one or more of: operational status and information regarding whether a Wi-Fi connection is operational not, a device uptime figure, an amount of data sent or received through Wi-Fi; Bluetooth operational status; and NFC status. A variety of information about a device's display may be included, and display status information may include one or more test results regarding whether: a screen of the mobile device is cracked or not; a location of a crack on a screen of a device; a size and extent of a crack on a display of a mobile device; a current brightness level of a display; an indicator whether an LCD is functioning. Additionally, a power up status may include one or more of whether a mobile device powers up in a predetermined period of time, and whether a power button of a mobile device is operational; and audio status may include whether a volume up button or down button works within predetermined ranges, whether a speaker is outputting an audio signal at an expected volume level, whether a microphone is receiving audio inputs with acceptable gain, whether a microphone is receiving audio inputs at predetermined frequencies, and whether a speaker of the mobile device is producing audio signals at desired amplitudes at a range of frequencies.

Aspects of the present invention may present financial incentives for a device owner or insurance agent to expand the devices obtained during the discovery process, and potentially offer insurance/warranty coverage to additional identified parties. For example, one embodiment includes identifying one or more secondary devices not directly associated with the device owner, and presenting an incentive for the device owner to contact an owner of the one or more secondary devices not directly associated with the device owner to propose insurance or warranty coverage.

An additional aspect of the present invention provides an additional benefit to device owners in terms of updating/replacing devices that are discovered and identified. For example, a trade-in offer for one or more of the devices in the Full Device List may be presented to the device owner in addition to the proposed device coverage. In one embodiment, identifying information for devices in the list along with their diagnostic status information may be gathered and sent to a third party device recycler. After receiving responses from the third-party recycler, an offer may be extended to the device owner, and the offer may include a profit fee for the warranty/insurance agent if the device owner follows up on the offer by clicking a link to take the user to the website of the recycler with the relevant offer information. For example, the presented information may make a statement such as, “You have an Phone 7 in good to very good condition, would you be interested in trading it in? Trade-in Offer Value $115. (Click here for more info).”

In a related embodiment, if a device owner consents, all or part of the information gathered in the Full Device List may be provided to additional third parties for additional purposes: for example, if outdated or malfunctioning devices are in the manifest, OEMS or other equipment vendors may utilize the information to provision/replace the devices with minimal difficulty. Further, software configuration manifests may be obtained for all the device owner's devices so that out of date software may be more easily updated if desired by the account holder. In addition, device fingerprints of the devices may be maintained whether or not the primary user chooses to insure or obtain warranties for the devices in the manifest, so that in the event of loss (such as theft or loss in a fire) recovery/replacement of the ancillary devices is streamlined, especially in the event of a comprehensive home insurance policy.

There is further presented a system of the present invention that comprises a primary device comprising mobile device, the primary device comprising: a processor in communication with a memory; a user interface in communication with the processor, the user interface including a touch-sensitive display and a data entry interface; a communications module in communication with the processor and configured to provide a communications interface to a third-party server, the third-party server further including a database, a server processor and a server memory; wherein one or more of the memory of the primary device or the server memory includes instructions that when respectively executed by the processor or the server processor perform the steps of: presenting a primary device associated with a device owner for assessment of insurability and/or warrantability; performing a diagnostic assessment of one or more features of a primary device presented by a device owner; analyzing diagnostic assessment results regarding the primary device and storing the analyzed results in a database record in the database, the database record associated with an identifier of the primary device; identifying one or more secondary devices associated with the device owner; respectively associating a unique secondary device identifier with each identified secondary device and storing the respective secondary device identifier and data regarding each respective identified secondary device in the database record; for each identified secondary device, determine whether a diagnostic assessment should be performed, and if so, perform a diagnostic assessment of one or more device features of such identified secondary device, storing results of the diagnostic assessment in the database record associated with the respective secondary device identifier; respectively analyzing the database record the primary device diagnostic assessment and each identified secondary device diagnostic assessment to determine options regarding insurance or warranty coverage; and presenting a list identifying the primary device and identified secondary devices along with respective options regarding insurance or warranty coverage to the primary owner. Various steps as recited above in regards to FIGS. 3-4 may also be included and as processed by the disclosed system.

In yet another embodiment the Full Device List or database record associated with the primary device may be stored in a blockchain database format. One advantage of this data structure is its incorruptible nature; rather, unmanaged or unauthorized changes in the database may be easily detected. Further, in some implementations, a blockchain data structure may provide for contract auto-execution features including payment, updating premium values, automatic price adjustments and rebates based on changes risk and package coverage (e.g., value pricing) Also, whether the data record is implemented through a blockchain or other conventional database structure, privacy could be preserved through encryption. In one embodiment, claims may be submitted, tracked, and resolved through the same blockchain for each covered device (through this process, its policy may be checked to ensure it hasn't expired very easily this way; also policy terms could be reviewed). The blockchain aspect may also be valuable for insurers to detect if there has been database corruption or hacking, e.g. a fraudster tries to fraudulently add a broken device to the list with information indicating that it is fully functional, setting the fraudster up to submit a fraudulent claim. In yet another feature, resale of policies or vendor intervention can be covered by pruning a part of the blockchain for coverage by a different vendor, e.g. in various scenarios, auto-based policy vs mobile device policy vs home policy.

An additional method of the present invention involves the diagnostic analysis of a primary mobile device without initial regard to any secondary devices, where diagnostics regarding the primary device may be performed through a variety of techniques, either locally, remotely through a web-based interface, through a software development kit, or through any combination thereof. Thus, there is presented a method including presenting a primary device associated with a device owner for assessment of insurability and/or warrantability; performing a diagnostic assessment of one or more features of the primary device; analyzing diagnostic assessment results regarding the primary device through use of one or more of: an app installed on the primary device; a software development kit installed via an app previously installed on the primary device; and a web-based interface through visiting, by the primary device, a web page which is configured to communicate with the primary device to initiate one or more diagnostic tests on the primary device, and then analyze results of the diagnostic tests and storing the analyzed results in a database record associated with an identifier of the primary device. After the results of the diagnostics are analyzed, Insurance/warranty options may be presented to a primary owner of the primary device.

Similar tests may be conducted only on the primary device, as they may be for the primary or secondary devices above, and results regarding insurance options, changes, and usage profiles may similarly be applied solely to the primary device.

Yet another method of the present invention can be used in parallel to others disclosed above. In this aspect, the device owner sends a link to phones/tablets that the device owner has contact with (which may be referred to as “Family Devices”). The link may be sent through a third party app (Messenger, WhatsApp etc.) and directs to a webpage where the user (family member) can run certain diagnostic tests to determine the condition of their device, such as checking the touchscreen or screen glass. These tests are also configurable, giving the insurer the option to gather the most important information about the device and manage risk. Diagnostic results of these tested devices are viewable on the management portal as well. Once the tests have been successfully run, the details of the results (passes or fail) determine the status of the device (eligible or ineligible to be insured). The primary policy holder will be able to view the status of each device and select eligible devices to be added to their new quote.

The primary policy holder may have several connected devices and family devices selected to form of a new quote. The quote details can be reviewed before the primary policy holder decides to commit and “Add to Bill”. The primary policy holder may also continue to use app after the insurance policy update to view the inventory of protected devices as well as policy and premium details.

As an optional incentive, to reward and engage the policy holder, they are given the option to avail from a discount or ‘bonus’ by inviting a friend to use the app (or use the insurance company) once their purchase has been completed. This is done by sharing a referral link using a third party application (SMS, WhatsApp etc.).

In addition to the method described above, one proposed implementation includes a method utilizing the following steps:

1. Opening a “master account” with an insurance provider.—This step may be performed after step 2 as well, but here it is the first step so that references to “master account” make sense.)

2. Performing diagnostics tests on the Device Owner's primary device either by installing (and running) a diagnostics application on the primary device or by using a web-based service running on a remote server (which is in communication with the primary device). Those of skill in the relevant arts appreciate that in alternate embodiments, the primary device may be a non-mobile device such as a desktop computer, a smart television, or an IOT-connected device. In an alternate embodiment, the primary device may be designated by the Device Owner through a web-based interface, and diagnostics may be executed remotely.

3. Warranty/Insurance coverage available for the primary device is defined in response to the diagnostics test result, and the device is added to a device list, which is maintained electronically by the insurance provider. For example, if the diagnostics tests indicate that the GPS functionality is not operational, the device might only be eligible for “broken glass” insurance instead of full insurance coverage.

4. Step 2-3 may be repeated for any additional mobile devices owned by the device owner or his/her family members, wherein these devices get added onto the device list as well. This may be done locally by the device owner after logging into his or her account (and additionally running the diagnostics tests if required); alternatively, this may be done remotely, such that the device owner sends an invite from the primary device to the devices of his/her family members prompting them to perform steps 2-3. The criteria might differ depending on the owner of the device: e.g. the device belonging to the primary device owner might go through a more rigorous regime initially when the account is opened, which may comprise requesting the primary device owner to provide evidence of his/her identity.

6. Steps 2-3 may be repeated for any non-mobile devices owned by the primary device owner, wherein these devices get added onto the device list as well: Network-connected devices, such as modern household appliances, may be added by performing a scan of the local area network. Devices without network-connectivity (or even non-digital devices) may be added by recording their properties using another device, for example by taking photographs of the device using the “master device” with any additional evidence of the ownership.

In one aspect, upon permission granted by the primary owner, a dynamic insurance coverage evaluator may remain active and running on the primary mobile device for some period of time after installation. The evaluator may accomplish a variety of purposes, including accumulating a list of candidate devices that communicate with the primary mobile device over time, determining whether such devices are already covered under a policy of the primary mobile device owner, and if not, offer to add such devices to the policy either periodically or when prompted by the primary owner's use of the insurance evaluator. The policy evaluator may, with primary account holder permission, access certain access logs stored on the mobile device or an external server, such as a server of a mobile network operator, to accumulate a list of candidate devices for insurance. In one embodiment, when prompted, or alternatively at some predetermined period of time, a list is presented to the primary account holder showing the list of insured devices, any relevant coverage, and identified candidates for addition to the list. Alternatively, the app may evaluate the usage conditions of the alternate devices (where, when, by whom, how often, risk factors such as amount and frequency of mobility, age of user etc.) and may present the list of known devices by coverage level (sufficiently covered, inadequately covered (additional coverage suggested) or over covered (presenting an opportunity to save money on a policy). Policy payments can then be adjusted based on dynamic coverage of a suite of the primary and secondary devices, and can change based on the coverage allotted to the secondary mobile devices. Certain incentives (such as bulk coverage or package deals) may also be offered to incentivize the primary owner to add devices to the list that otherwise the insured may not consider adding, such as coverage for inexpensive IoT devices. In yet another embodiment, a “hub” component such as a router or smart speaker (google home, Alexa, etc.) is designated by the primary device owner as a “home” hub, and this device then is enabled to have a skill or software installed that accumulates and maintains a usage log of accessing devices, thus adding more to the potential list of accessible devices. During the discovery process, device classes can be created, such as IoT- or wireless-enabled medical devices that may not be added to the list for privacy reasons. In yet another embodiment, device usage can be tracked over time, a risk profile is created and automatically scaled based on usage criteria of the devices, and insurance rates can be therefore dynamically adjusted for all devices in the primary owner's account list; e.g. a primary device owner's child is taking their phone to the beach a lot, therefore, the rate should increase as the risk of damage is increased by its usage profile.

7. The full device list is presented to the primary device owner (i.e. list of devices added to the insurance plan in steps 3-6), as well as a proposal for an insurance plan (i.e. pricing and coverage of the protection per device).

8. The primary device owner selects the devices he/she wishes to cover by the insurance and approves the insurance plan for billing.

9. Additionally (and optionally), the primary device owner may share the app with others for monetary reward (not to be protected under their policy).

10. Additionally, primary device owner may at any point review the monthly premium, the listing of protected devices, add or remove devices from the approved insurance plan.

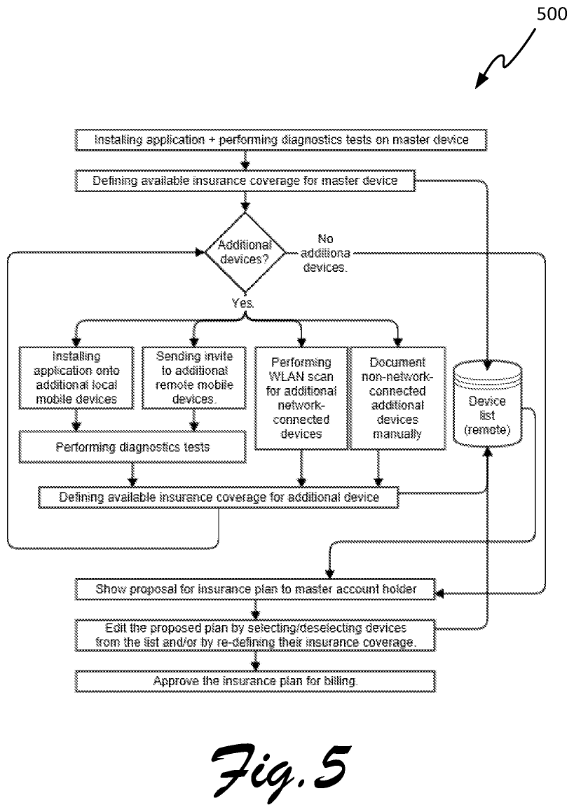

Another alternate illustration for a system and method 500 of the present invention, covering aspects described above and other aspects, is illustrated in FIG. 5.

In one additional aspect a presentation application that is accessed by the primary device may also provide a claim submittal/adjustment feature to automate or assist users with submitting and tracking claims submitted to the insurance agency. Amount of coverage can be confirmed, the amount of payout provided, and reasons for payment or nonpayment provided to the primary device owner. Also, device replacement can be tracked when that is offered as a claim outcome for the provided insurance policy.

Regarding diagnostic techniques for mobile devices describe above, an embodiment of the present invention may, through a serial connection or a USB-type connection communicate directly with the hardware of mobile device to obtain relevant information from the device without initial installation of an app on the mobile device. In various embodiments of the present invention, detailed product, vendor, and status information may be obtained from the mobile device quickly and even if a display of the mobile is non-functional, or if a battery of the mobile device is in a discharged state. Further, diagnostics and certain provisioning actions may be performed by a host system connected to a mobile device without the need to install an app on the mobile device. Additionally, in various embodiments, a mobile carrier may conduct analytics and mobile device provisioning in a retail setting without the need to purchase additional hardware beyond a computer system configured to operate methods of the present invention along with interface cables as described herein. In the retail setting or in a kiosk, a mobile device may be attached to the test system via a USB cable, and a web browser configured with a plugin may operate on a computer or tablet of the retail vendor/kiosk to conduct diagnostic testing and/or provisioning of the connected mobile device in accordance with aspects of the invention described herein.

In additional embodiments of the present invention, thorough serial connections established between and the mobile device and the host system, sophisticated analytics, diagnostics, and provisioning functions such as erasure may be conducted without the need to have a user or test system first install an app on the mobile device. Further, various embodiments may conduct diagnostics and provisioning of a mobile device without rooting or jailbreaking the mobile devices from their factory-set condition.

Aspects of the present invention may also include installation of a security application on a provided mobile device such as the primary device; executing a device audit function whereby device configuration parameters are obtained regarding the mobile device, determining a unique device ID for the mobile device from the device configuration parameters; storing the device configuration parameters in an insurance tracking database in a record associated with the device ID; and associating the device ID in the insurance tracking database with an authorized user of the mobile device. The audit function may be performed by the security application on the mobile device or by a computing device attached to the mobile device or by a combination thereof. Any appropriate device configuration parameters may be included in the insurance tracking database, including parameters such as a device type, a manufacturer, a model number, a serial number, a manufacturing date, a hardware configuration list, a memory capacity, a software manifest, a list of operable features, a list of inoperable features, an electronic serial number, an ESN, an IMEI number, an international mobile equipment identifier number, an IMSI number, an international mobile subscriber identity number, a UIMID number, and a user identity module identifier. Embodiments involving SIM cards (such as interchangeable Subscriber Identity Modules commonly used with cellular telephones) with a method of the present invention also include determining that at least one of the stored device configuration parameters includes an IMSI number within a SIM of the device; flagging in the insurance tracking database a parameter that indicates that any mobile device that possesses a SIM with the included the IMSI within the SIM should be covered under a provided insurance policy. Another implementation includes receiving an insurance claim regarding a loss event pertaining to the mobile device; and making an assessment that the claim is likely fraudulent by: determining that a SIM card associated with the mobile device has been inserted into a second mobile device prior to the reported date of loss of the mobile device by: retrieving from the insurance tracking database the IMSI number associated with the SIM card of the mobile device; submitting a query to a mobile network operator comprising the IMSI number and a date of first use in a currently operating mobile device; and finding from the mobile network operator that the date of first use of the IMSI in the current mobile device precedes a reported date of loss of the mobile device and antedates a date of installation of the security application in the mobile device. Any appropriate types of identifiers may be utilized in concert with embodiments of the present invention, and regarding device fingerprints, or unique electronic representations of a hardware component, there is a provided a method comprising computing an electronic device fingerprint that uniquely identifies the mobile device; and storing the fingerprint in the insurance tracking database as associated with the authorized user.

Device location may also be utilized to assist with detecting and deterring fraud in relationship to insurance policies for mobile devices. In one embodiment, through a provided interface to a mobile network operator, a method is provided for obtaining mobile device location information corresponding to the device ID; and storing the location information in the insurance tracking database record associated with the device ID. The location of the mobile device may be obtained by any conventional method, such as through a provided interface to a Location-as-a-Service provider, obtaining mobile device location information corresponding to the device ID; and storing the location information in the insurance tracking database record associated with the device ID.

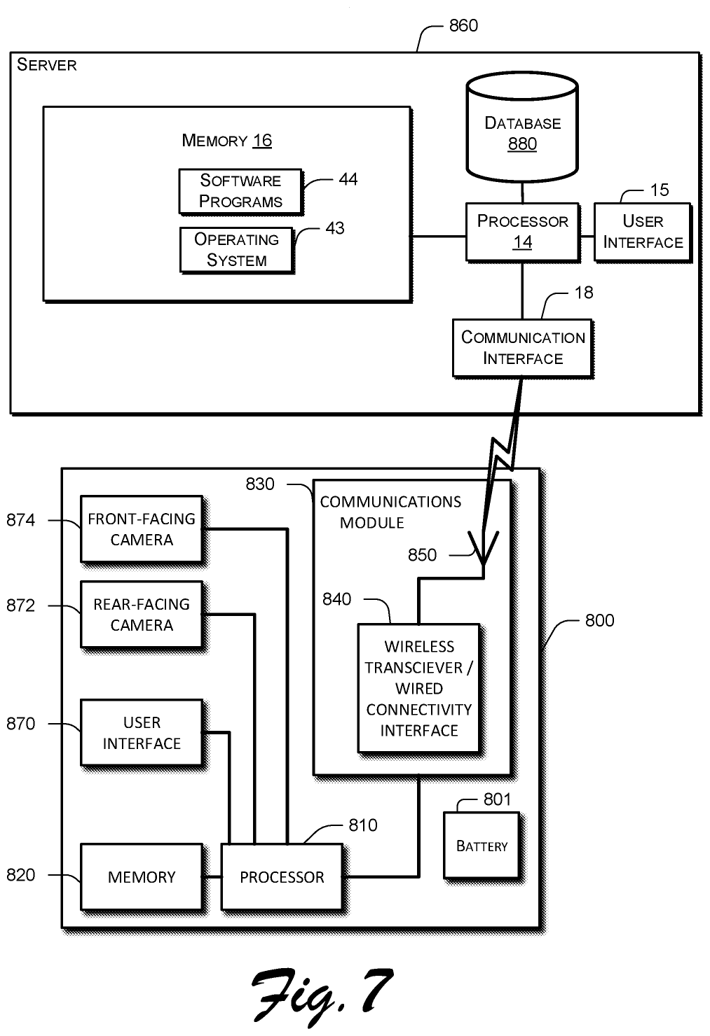

The exemplary system depicted in FIG. 1 may be alternatively shown in FIG. 7, and in an embodiment comprises a mobile device 800 (which may comprise, in some embodiments, one of primary device 100 or secondary devices 150, 160, 165) that includes a processor 810 coupled to a memory 820 which may include volatile memory, nonvolatile memory (such as FLASH memory) or a combination thereof. A communications module 830 comprises a wireless transceiver 840 for wirelessly communicating with one or more servers, such as host server 860 and other entities through antenna 850, although those of skill in the art may appreciate that a wired connection may be established to provide connectivity in lieu of or in addition to the wireless connection. The mobile device also includes a user interface 870 coupled to the processor 810. The mobile device 800 may include any suitable power source, such as a battery 801. The mobile device 800 may include any other desired components, such as a global positioning system (GPS) to provide geolocation information for locating the mobile device. Some or all of the components of the mobile device 800 may include (or be in communication with) a hardware identification module (not shown) such as a universal subscriber identity module and/or removable user identity module. The hardware identification module may be coupled to the processor 810 and may include an identifier that can be compared to a predetermined identifier to determine whether the hardware of the mobile device 800 has been altered. The hardware identification module (and predetermined identifier) may include any suitable identifier, such as an electronic serial number, a local area identity identifier, an integrated circuit identifier, an international mobile subscriber identifier, an authentication key identifier, and/or an operator-specific emergency number identifier. The identifier may be stored in the memory 820 and transmitted to the host server 860 for comparison to a predetermined identifier.

The functionality of the mobile device 800, including the methods described herein (in whole or in part), may be implemented through the processor 810 executing computer-readable instructions stored in the memory 820 of the mobile device 800. The memory 820 may store any computer-readable instructions and data, including software applications, user-installed or third-party-installed “apps,” applets, and embedded operating code.

Additionally, the software application may be configured to operate with minimal underlying hardware functionality. For example, the application may be initiated before the mobile device establishes a network connection. Such a situation may be provided, for instance, when the software application is installed on a SIM card in the mobile device, and the application launches before other software in the mobile device operating system. Alternately or in addition, a data element such as a link or a URL (universal resource locator) may reside on the SIM card, and by launching an application such as a browser with the URL or link, an application referenced by the link or URL may be loaded into the mobile device from a remote server and/or executed directly from on the remote server.

Software performing methods of the present invention may be provided with the device or downloaded onto the mobile device by an authorized user, and/or may be further resident in memory 16 of the host server 860 and executable by the server processor 14. The functionality of the mobile device 800 as well as the host server 860 may also be implemented through various hardware components storing machine-readable instructions, such as application-specific integrated circuits (ASICs), field-programmable gate arrays (FPGAs) and/or complex programmable logic devices (CPLDs), graphics processing units (GPUs), and neural network processing or simulation circuits. Systems according to aspects of the present invention may operate in conjunction with any desired combination of software and/or hardware components.

The processor 810 retrieves and executes instructions stored in the memory 820 to control the operation of the mobile device 800. Similarly the server processor 14 retrieves and executes instructions stored in the server memory 16 to control the operation of the host server 860. Any number and type of processor such as an integrated circuit microprocessor, microcontroller, and/or digital signal processor (DSP), can be used in conjunction with the present invention. The memory 820 stores instructions, data, messages transmitted from (or received by) the mobile device 800, and any other suitable information, and the server memory 16 similarly stores instructions, data, messages transmitted from (or received by) the host server 860, and any other suitable information. A memory 820 and server memory 16 operating in conjunction with the present invention may include any combination of different memory storage devices, such as hard drives, random access memory (RAM), read only memory (ROM), FLASH memory, or any other type of volatile and/or nonvolatile memory. Data can be stored in the memory 820 or server memory 16 in any desired manner.

The communications interface 830 communicates with one or more servers such as host server 860, or other suitable entities. In like manner, the communication interface 18 of the host server is configured to communicate with the mobile device 800, a general network such as the Internet, or any other suitable entity. Any suitable communications device, component, system, and method may be used in conjunction with the present invention. For example, the wireless transceiver 840 may be configured to communicate using any number and type of cellular protocols, such as General Packet Radio Service (GPRS), Global System for Mobile Communications (GSM), Enhanced Data rates for GSM Evolution (EDGE), Personal Communication Service (PCS), Advanced Mobile Phone System (AMPS), Code Division Multiple Access (CDMA), Wideband CDMA (W-CDMA), Time Division-Synchronous CDMA (TD-SCDMA), Universal Mobile Telecommunications System (UMTS), and/or Time Division Multiple Access (TDMA). A mobile device operating in conjunction with the present invention may alternatively (or additionally) include wireless transceiver(s) (and related components) to communicate using any other method of wireless communication protocol, such as an ISO 14443 protocol, an ISO 18000-6 protocol, a Bluetooth protocol, a Zigbee protocol, a Wibree protocol, a WiFi protocol, an IEEE 802.15 protocol, an IEEE 802.11 protocol, an IEEE 802.16 protocol, an ultra-wideband (UWB) protocol; an IrDA protocol, and combinations thereof; and further, the communication interface 18 of host server 860 may be configured to operate with such protocols to communicate with the mobile device 800 or any other device. The antenna 850 may be configured to transmit and receive any wireless signal in any format, and may comprise a plurality of different antennas to transmit and receive using different wireless protocols.

The communications module 830 can communicate with the server 860 or another device using any other form of connection, such as a wired Internet connection, a wireless Internet connection, a cellular telephone network connection (including a data link connection), a wireless LAN connection, a wireless WAN connection, an optical connection, a Firewire connection, Thunderbolt connection, a Lightening port connection, an e-SATA connection, a USB connection, a mobile device synchronization port connection, a power connection, and/or a security cable. The communications module 830 can be used to communicate with one or more companion devices to monitor the position or status of the mobile device 800 (e.g., by monitoring whether a communication link between the mobile device and companion device is intact), as well as with any number of other devices to help track/locate a lost or stolen mobile device 800.

The mobile device 800 includes a user interface 870. The user interface 870 may include any number of input devices (not shown) to receive commands, data, and other suitable input from a user, as well as any number of output devices (not shown) to provide the user with data, notifications, and other suitable information from the mobile device 800. Likewise, the host server 860 includes user interface 15, and may include any number of input devices (not shown) to receive commands, data, and other suitable input from a user or third party, as well as any number of output devices (not shown) to provide the user/third party with data, notifications, and other suitable information from the host server 860.

Any number of input devices may be included in the user interfaces 870, 15 such as touch pads, touch screens, a mouse/trackball/trackpad, a microphone, and/or an alphanumeric keypad to allow a user to enter instructions and data into the mobile device 800 and host server 860. The term “touch screen” for purposes of the present application may include a display integrated with or in close proximity to a touch interface that is capable of determining when a user applies physical connection to a location proximate the display. The touch screen may have sensors that can measure parameters from the user's interaction, and such sensors may measure capacitance, resistance, pressure, or differential readings resulting from movement of a “touch” to the screen. The user interface 870 may be configured to detect pressure exerted by a user on the keys of a keypad (virtually implemented on the display, or as a physical array of key switches), as well as the time interval between key presses in order to determine if the current user is authorized to use the device. The user interface 870 may also include a microphone to allow the user to provide audio data to the mobile device 800, as well one or more cameras to allow the mobile device to capture still or video images. Similarly, the user interface 15 of the host server 860 may include a microphone to allow a user to provide audio data to the host server 860, as well one or more cameras to allow the server 860 to capture still or video images. In one embodiment, the mobile device 800 comprises a front-facing camera 874 that faces the user when the device is in operation, and a rear-facing camera 872 on an opposite side of the mobile device. The mobile device 800 may include speech recognition software to process verbal input through the user interface 870. The user interface 870, and similarly the server user interface 15 may also include any number of suitable output devices, such as a display screen to visually display information (such as video and text), and/or a speaker to provide auditory output. The display of the mobile device may be configured to sense user touches by any appropriate means, such as capacitive sensing, pressure sensing, gel displacement sensing, resistive sensing, or any other appropriate or conventional touch sending technology utilized by those of skill in the relevant arts. The mobile device 800 may be configured to provide words, phrases, tones, recorded music, or any other type of auditory output to a user through the speaker. As discussed previously, the user interface 870 can be activated to provide information and/or hinder the operation of the mobile device 800 when an unauthorized user attempts to use the mobile device 800. For example, the illumination level of the display may be modulated to draw attention to the mobile device, and unpleasant and/or loud sounds can be played over the speaker.

The mobile device 800 may include one or more biometric devices configured to receive biometric information, such as a fingerprint scanner, an iris scanner, a retinal scanner, and/or a breath analyzer. Input devices such as a microphone or camera may also be utilized to perform biometric analyses, such as a voice analysis or facial recognition. Further, the mobile device may include a magnetometer for measuring magnetic fields (such as may be utilized in an electronic compass), a MEMS or other type of gyroscope for measuring attitude, and accelerometers for measuring changes in movement of the mobile device.

Information provided or received by the user interfaces 870, 15 may be in any appropriate format. For example, a user interface that communicates information to a user in an auditory format may first provide a data header followed by a data value to identify the data to the user. The user interfaces 870, 15 may provide information in any number of desired languages, regardless of whether the information is provided audibly or visually.

The user interfaces 870, 15 can also provide/receive information to a user in a machine-readable format. In one exemplary embodiment of the present invention, for example, the user interface 870 of a mobile device 800 may send and receive messages using dual-tone multi-frequency (DTMF) tones. The mobile device 800 and host server 860 can be configured to send, receive, and process machine-readable data in any standard format (such as a MS Word document, Adobe PDF file, ASCII text file, JPEG, or other standard format) as well as any proprietary format. Machine-readable data to or from the user interfaces 830, 15 may also be encrypted to protect the data from unintended recipients and/or improper use. In an alternate embodiment, a user must enter a passcode to enable use of some or all of the functionality of the mobile device 800. Any other user interface feature may be utilized to allow a human or non-human user to interact with one or more devices operating in conjunction with the present invention.

The mobile device 800 may include any other suitable features, components, and/or systems. For example, the mobile device 800 may be configured to preserve the life of its battery by shutting off some or all of its components, such as a camera or microphone. Components can be selectively shut down in response to a security compromise event, as well as in response to a command from an authorized user or security authority. Alternately, the mobile device 800 can be configured to use its components excessively to drain the battery as quickly as possible, to, for example, limit the usefulness of the mobile device 800 to an unauthorized user.

The mobile device 800 may be configured to implement one or more security measures to protect data, restrict access, or provide any other desired security feature. For example, a mobile device 800 may encrypt transmitted data and/or data stored within or created by the device itself. Such security measures may be implemented using hardware, software, or a combination thereof. Any method of data encryption or protection may be utilized in conjunction with the present invention, such as public/private keyed encryption systems, data scrambling methods, hardware and software firewalls, tamper-resistant or tamper-responsive memory storage devices or any other method or technique for protecting data. Similarly, passwords, biometrics, access cards or other hardware, or any other system, device, and/or method may be employed to restrict access to any device operating in conjunction with the present invention.

The host server 860 communicates with mobile devices 800, authorized users, unauthorized users, security authorities, and other entities to monitor and protect the mobile devices 800 from unauthorized use and to mitigate the harm associated with a security compromise event or attempted fraud. The host server 860 may comprise any number of separate computer systems, processors, and memory storage devices, and any other suitable entity. The host server 860 may include, or be in communication with, one or more databases 880 storing information regarding authorized users and mobile devices 800 in order to monitor and track the mobile devices 800 and provide instructions to the mobile devices 800 in the event a security compromise event occurs.

For example, a database 880 may store a usage profile for a mobile device to allow software on the host server 860 to detect whether continued usage of the mobile device deviates from the usage profile by a predetermined threshold, or whether the mobile device has incurred a loss event resulting in a fault state within the mobile device 800. The host server 860 may also receive, process, and store (e.g., in the database 880) information from the mobile device 800. The host server 860 may handle any type of data in any format to achieve any purpose, such as receiving and processing environmental parameters captured by the mobile device to track the position and location of the mobile device 800 as discussed previously. The database 880 may also store location information that can be used to determine whether the mobile device 800 is operating in a valid location (e.g., “whitelisting” and “blacklisting” as discussed previously). The database 880 may also store neural network training data, wherein exemplary images of defects in mobile devices are correspondingly associated with identified defect classes, outputs or states. The neural network training data may be augmented or otherwise modified to improve accuracy of recognition of device defects. Further, database 880 may store results of analysis of the health and operation of mobile device 800, along with identifying information and historical operational information associate with mobile device 800. In this manner, operational analysis of the mobile device may be tracked and analyzed over time by server 860, and trends identified that may indicate pending failure of at least one component of mobile device 800.

Databases 880 in communication with the host server 860 may also store archived data from mobile devices 800 for recovery in the event the mobile devices 800 are lost or stolen, or the data on the mobile devices 800 is destroyed (e.g., by a virus or other malicious program). The functionality of the host server 860 may be performed automatically or semi-automatically, such as through software/hardware operating on one or more computer systems, and/or by one or more human operators.

The host server 860 may include one or more system processors 14 that retrieve and execute computer-readable instructions stored in a memory 16 to control (at least partially) the operation of the host server 860. Any number and type of conventional computer, computer system, computer network, computer workstation, minicomputer, mainframe computer, or computer processor, such as an integrated circuit microprocessor or microcontroller, can be used in conjunction with the present invention. Computer systems used in accordance with aspects of the present invention may include an operating system 43 (e.g., Windows NT/95/98/2000/XPNista/7/8/10, OS2, UNIX, Linux, Solaris, MacOS, etc.) as well as various conventional support software and drivers typically associated with computers. In certain embodiments, dedicated applications may be entirely or partially served or executed by the system processor to perform methods of the present invention.

The particular implementations shown and described herein are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims, which illustrate non-limiting embodiments of the present invention.

What is claimed is:

1. A method comprising:
presenting a primary device associated with a device owner for assessment of insurability and/or warrantability;
performing a diagnostic assessment of one or more features of the primary device;
analyzing diagnostic assessment results regarding the primary device and storing the analyzed results in a database record associated with an identifier of the primary device;
identifying one or more secondary devices associated with the device owner;
respectively associating a unique secondary device identifier with each identified secondary device and storing the respective secondary device identifier and data regarding each respective identified secondary device in the database record;
for each identified secondary device, determine whether a diagnostic assessment should be performed, and if so, perform a diagnostic assessment of one or more device features of such identified secondary device, storing results of the diagnostic assessment in the database record associated with the respective secondary device identifier;
respectively analyzing the database record the primary device diagnostic assessment and each identified secondary device diagnostic assessment to determine options regarding insurance or warranty coverage; and
presenting a list identifying the primary device and identified secondary devices along with respective options regarding insurance or warranty coverage to the primary owner.

2. The method of claim 1, wherein the primary device is one of a smartphone, a mobile electronic device, a desktop computer, a tablet, or a smart vehicle.

3. The method of claim 1, wherein a secondary device includes one or more of a modem, a router, a smart appliance, an IoT device, a smart hub, a home alarm, a smart TV a tablet, a streaming device, a desktop computer, a computer peripheral, a printer, a smart charger, a smart watch, smart personal devices, and a vehicle.

4. The method of claim 1, wherein the primary device is a mobile smartphone, and further comprising installing an app on the primary device to perform the diagnostic assessment of one or more features of the primary device.

5. The method of claim 5, further comprising performing the diagnostic assessment of one or more features of the primary device in a remote server communicatively coupled to the primary device.

6. The method of claim 1, wherein a secondary device is a mobile smartphone, and further comprising remotely installing an app on the secondary device to perform the diagnostic assessment of one or more features of the secondary device.

7. The method of claim 1, wherein identifying one or more secondary devices associated with the device owner further comprises one or more of:
scanning a network that is communicatively coupled to the primary device and itemizing devices found included in the network;
contacting a mobile network operator providing service to the primary device, and obtaining, from the mobile network operator, a list of devices in a group service plan with the primary device;
manually entering, by the device owner, information regarding the one or more secondary devices; and
sending an email or text message to an account accessible by a secondary device, and prompting a user of the secondary device to click on a link to provide information about the secondary device.

8. The method of claim 1, wherein performing a diagnostic assessment of one or more device features of an identified secondary device includes requesting the secondary device perform a self-test; and receiving results of the self-test.

9. The method of claim 1, further comprising prompting the device owner to select coverage options from presented coverage options for each of the primary device and secondary devices, and storing the selections in the database record.

10. The method of claim 1, wherein presenting a list further comprises computing and displaying to the device owner a total monthly premium for elected insurance or warranty options.

11. The method of claim 1, further comprising analyzing one of the primary device and a secondary device and updating the database record to reflect an updated analysis.

12. The method of claim 1, further comprising re-assessing respective options regarding insurance or warranty coverage and presenting an updated list of options to the primary user.

13. The method of claim 1, wherein options regarding insurance or warranty coverage options include cost of coverage, policy terms, premium payment amounts, claim caps for identified device feature repairs, device features included in coverage, device features excluded from coverage, and cost to obtain additional and/or enhanced coverage.

14. The method of claim 1, wherein determining whether a diagnostic assessment should be performed further comprises determining that a diagnostic assessment for a secondary device may be executed at a future time; and offering insurance or warranty coverage at an enhanced price until such assessment may be conducted.

15. The method of claim 1, further comprising:
installing a dynamic coverage evaluator app on one or more of the primary device and a secondary device, wherein the dynamic coverage evaluator app may remain active and execute in the background of such mobile device, wherein the dynamic coverage evaluator:
accumulates a list of candidate devices that communicate with the mobile device over time;
determines whether such candidate devices are already covered under a policy of the primary device owner;
and if not, offers to add such uncovered devices to the device owner's policy either periodically or when prompted by the primary owner's use of the dynamic coverage evaluator.

16. The method of claim 1, wherein an identifier of the primary device may include one or more of: a device's make, model, IMEI, phone number, device ID, device tag, account number, serial number, and a device fingerprint value.

17. The method of claim 1, wherein performing a diagnostic assessment of one of the primary device or a secondary device includes obtaining one or more of device identifying information, device orientation sensor status, battery status, branding labeling information, location information, memory information, device local radio operation, display status, housing status; device power up status, and audio status.

18. The method of claim 17, wherein device orientation sensor status may include one or more of an operational status and a current value of a device's magnetometer, accelerometer, gyroscope, pressure sensor, or a sensor used by the device in obtaining its physical orientation.

19. The method of claim 17, wherein battery status may include one or more of information regarding whether a device's battery is charged; whether the battery is capable of holding a charge; an estimated capacity comparison to original specification of a battery; a battery maximum and/or minimum level, and a current charging type.

20. The method of claim 17, wherein location information may include one or more of locale indicators; GPS information; location data services information; connected wireless tower information; and visited Wi-Fi domains.

21. The method of claim 17, wherein memory information includes one or more of: an average memory usage of a device; a maximum and minimum memory usage of a device; storage capacity of a device; storage used by a device; internal memory/storage of a device; and external memory card status and/or capacity of a device.

22. The method of claim 17, wherein device local radio operation includes one or more of: operational status and information regarding whether a Wi-Fi connection is operational not, a device uptime figure, an amount of data sent or received through Wi-Fi; Bluetooth operational status; and NFC status.

23. The method of claim 17, wherein display status information includes one or more test results regarding whether: a screen of the mobile device is cracked or not; a location of a crack on a screen of a device; a size and extent of a crack on a display of a mobile device; a current brightness level of a display; an indicator whether an LCD is functioning.

24. The method of claim 17, wherein power up status includes one or more of whether a mobile device powers up in a predetermined period of time, and whether a power button of a mobile device is operational.

25. The method of claim 17, wherein audio status may include whether a volume up button or down button works within predetermined ranges; whether a speaker is outputting an audio signal at an expected volume level, whether a microphone is receiving audio inputs with acceptable gain, whether a microphone is receiving audio inputs at predetermined frequencies, and whether a speaker of the mobile device is producing audio signals at desired amplitudes at a range of frequencies.

26. The method of claim 1, further comprising: identifying one or more secondary devices not directly associated with the device owner, and presenting an incentive for the device owner to contact an owner of the one or more secondary devices not directly associated with the device owner to propose insurance or warranty coverage.

27. The method of claim 1, wherein the database record is at least partially stored in a database server managed by a third-party insurance or warranty provider, and where in the database server is communicatively coupled to the primary device.

26. The method of claim 1, further comprising dynamically adjusting a monthly premium amount based on usage profiles of the primary device and the secondary device.

27. The method of claim 26, wherein the usage profiles include parameters related to risk of loss, damage, or aging of any of the primary device or secondary devices.

28. A system comprising:
a primary device comprising mobile device, the primary device comprising:
a processor in communication with a memory;
a user interface in communication with the processor, the user interface including a touch-sensitive display and a data entry interface;
a communications module in communication with the processor and configured to provide a communications interface to a third-party server, the third-party server further including a database, a server processor and a server memory;
wherein one or more of the memory of the primary device or the server memory includes instructions that when respectively executed by the processor or the server processor perform the steps of:
presenting a primary device associated with a device owner for assessment of insurability and/or warrantability;
performing a diagnostic assessment of one or more features of a primary device presented by a device owner;
analyzing diagnostic assessment results regarding the primary device and storing the analyzed results in a database record in the database, the database record associated with an identifier of the primary device;
identifying one or more secondary devices associated with the device owner;
respectively associating a unique secondary device identifier with each identified secondary device and storing the respective secondary device identifier and data regarding each respective identified secondary device in the database record;
for each identified secondary device, determine whether a diagnostic assessment should be performed, and if so, perform a diagnostic assessment of one or more device features of such identified secondary device, storing results of the diagnostic assessment in the database record associated with the respective secondary device identifier;
respectively analyzing the database record the primary device diagnostic assessment and each identified secondary device diagnostic assessment to determine options regarding insurance or warranty coverage; and
presenting a list identifying the primary device and identified secondary devices along with respective options regarding insurance or warranty coverage to the primary owner.

29. The system of claim 28, wherein the primary device is one of a smartphone, a mobile electronic device, a desktop computer, a tablet, or a smart vehicle.

30. The system of claim 28, wherein a secondary device includes one or more of a modem, a router, a smart appliance, an IoT device, a smart hub, a home alarm, a smart TV a tablet, a streaming device, a desktop computer, a computer peripheral, a printer, a smart charger, a smart watch, smart personal devices, and a vehicle.

31. The system of claim 28, wherein the primary device is a mobile smartphone, and further comprising installing an app on the primary device to perform the diagnostic assessment of one or more features of the primary device.

32. The system of claim 28, further comprising performing the diagnostic assessment of one or more features of the primary device in the server communicatively coupled to the primary device.

33. The system of claim 28, wherein a secondary device is a mobile smartphone, and further comprising remotely installing an app on the secondary device to perform the diagnostic assessment of one or more features of the secondary device.

34. The system of claim 28, wherein identifying one or more secondary devices associated with the device owner further comprises one or more of:
scanning a network that is communicatively coupled to the primary device and itemizing devices found included in the network;
contacting a mobile network operator providing service to the primary device, and obtaining, from the mobile network operator, a list of devices in a group service plan with the primary device;
manually entering, by the device owner, information regarding the one or more secondary devices; and
sending an email or text message to an account accessible by a secondary device, and prompting a user of the secondary device to click on a link to provide information about the secondary device.

35. The system of claim 28, wherein performing a diagnostic assessment of one or more device features of an identified secondary device includes requesting the secondary device perform a self-test; and receiving results of the self-test.

36. The system of claim 28, further comprising prompting the device owner to select coverage options from presented coverage options for each of the primary device and secondary devices, and storing the selections in the database record.

37. The system of claim 28, wherein presenting a list further comprises computing and displaying to the device owner a total monthly premium for elected insurance or warranty options.

38. The system of claim 28, further comprising analyzing one of the primary device and a secondary device and updating the database record to reflect an updated analysis.

39. The system of claim 28, further comprising re-assessing respective options regarding insurance or warranty coverage and presenting an updated list of options to the primary user.

40. The system of claim 28, wherein options regarding insurance or warranty coverage options include cost of coverage, policy terms, premium payment amounts, claim caps for identified device feature repairs, device features included in coverage, device features excluded from coverage, and cost to obtain additional and/or enhanced coverage.

41. The system of claim 28, wherein determining whether a diagnostic assessment should be performed further comprises determining that a diagnostic assessment for a secondary device may be executed at a future time; and offering insurance or warranty coverage at an enhanced price until such assessment may be conducted.

42. The system of claim 28, further comprising:
installing a dynamic coverage evaluator app on one or more of the primary device and a secondary device, wherein the dynamic coverage evaluator app may remain active and execute in the background of such mobile device, wherein the dynamic coverage evaluator:
accumulates a list of candidate devices that communicate with the mobile device over time,
determines whether such candidate devices are already covered under a policy of the primary device owner,
and if not, offers to add such uncovered devices to the device owner's policy either periodically or when prompted by the primary owner's use of the dynamic coverage evaluator.

43. The system of claim 28, wherein an identifier of the primary device may include one or more of: a device's make, model, IMEI, phone number, device ID, device tag, account number, serial number, and a device fingerprint value.

44. The system of claim 28, wherein performing a diagnostic assessment of one of the primary device or a secondary device includes obtaining one or more of device identifying information, device orientation sensor status, battery status, branding labeling information, location information, memory information, device local radio operation, display status, housing status; device power up status, and audio status.

45. The system of claim 44, wherein device orientation sensor status may include one or more of an operational status and a current value of a device's magnetometer, accelerometer, gyroscope, pressure sensor, or a sensor used by the device in obtaining its physical orientation.

46. The system of claim 44, wherein battery status may include one or more of information regarding whether a device's battery is charged; whether the battery is capable of holding a charge; an estimated capacity comparison to original specification of a battery; a battery maximum and/or minimum level, and a current charging type.

47. The system of claim 44, wherein location information may include one or more of locale indicators; GPS information; location data services information; connected wireless tower information; and visited Wi-Fi domains.

48. The system of claim 44, wherein memory information includes one or more of: an average memory usage of a device; a maximum and minimum memory usage of a device; storage capacity of a device; storage used by a device; internal memory/storage of a device; and external memory card status and/or capacity of a device.

49. The system of claim 44, wherein device local radio operation includes one or more of: operational status and information regarding whether a Wi-Fi connection is operational not, a device uptime figure, an amount of data sent or received through Wi-Fi; Bluetooth operational status; and NFC status.

50. The system of claim 44, wherein display status information includes one or more test results regarding whether: a screen of the mobile device is cracked or not; a location of a crack on a screen of a device; a size and extent of a crack on a display of a mobile device; a current brightness level of a display; an indicator whether an LCD is functioning.

51. The system of claim 44, wherein power up status includes one or more of whether a mobile device powers up in a predetermined period of time, and whether a power button of a mobile device is operational.

52. The system of claim 44, wherein audio status may include whether a volume up button or down button works within predetermined ranges; whether a speaker is outputting an audio signal at an expected volume level, whether a microphone is receiving audio inputs with acceptable gain, whether a microphone is receiving audio inputs at predetermined frequencies, and whether a speaker of the mobile device is producing audio signals at desired amplitudes at a range of frequencies.

53. The system of claim 28, further comprising: identifying one or more secondary devices not directly associated with the device owner, and presenting an incentive for the device owner to contact an owner of the one or more secondary devices not directly associated with the device owner to propose insurance or warranty coverage.

54. The system of claim 28, further comprising dynamically adjusting a monthly premium amount based on usage profiles of the primary device and the secondary device.

55. The system of claim 54, wherein the usage profiles include parameters related to risk of loss, damage, or aging of any of the primary device or secondary devices.

56. A method comprising:
presenting a primary device associated with a device owner for assessment of insurability and/or warrantability;
performing a diagnostic assessment of one or more features of the primary device;
analyzing diagnostic assessment results regarding the primary device through use of one or more of:
an app installed on the primary device;
a software development kit installed via an app previously installed on the primary device; and
a web-based interface through visiting, by the primary device, a web page which is configured to communicate with the primary device to initiate one or more diagnostic tests on the primary device; and
analyze results of the diagnostic tests and storing the analyzed results in a database record associated with an identifier of the primary device.

57. The method of claim 56, further comprising:
analyzing the database record the primary device diagnostic assessment to determine options regarding insurance or warranty coverage; and
presenting options regarding insurance or warranty coverage of the primary device to the primary owner.

58. The method of claim 56, wherein the primary device is one of a smartphone, a mobile electronic device, a desktop computer, a tablet, or a smart vehicle.

59. The method of claim 56, wherein the primary device is a mobile smartphone, and further comprising installing an app on the primary device to perform the diagnostic assessment of one or more features of the primary device.

60. The method of claim 59, further comprising performing the diagnostic assessment of one or more features of the primary device in a remote server communicatively coupled to the primary device.

61. The method of claim 57, wherein presenting options further comprises computing and displaying to the device owner a total monthly premium for elected insurance or warranty options.

62. The method of claim 57, further comprising re-assessing respective options regarding insurance or warranty coverage and presenting an updated options to the primary user.

63. The method of claim 57, wherein options regarding insurance or warranty coverage options include cost of coverage, policy terms, premium payment amounts, claim caps for identified device feature repairs, device features included in coverage, device features excluded from coverage, and cost to obtain additional and/or enhanced coverage.

64. The method of claim 56, further comprising:
installing a dynamic coverage evaluator app on the primary device, wherein the dynamic coverage evaluator app may remain active and execute in the background of such mobile device, wherein the dynamic coverage evaluator:
accumulates a list of candidate devices that communicate with the mobile device over time;
determines whether such candidate devices are already covered under a policy of the primary device owner;
and if not, offers to add such uncovered devices to the device owner's policy either periodically or when prompted by the primary owner's use of the dynamic coverage evaluator.

65. The method of claim 56, wherein an identifier of the primary device may include one or more of: a device's make, model, IMEI, phone number, device ID, device tag, account number, serial number, and a device fingerprint value.

66. The method of claim 56, wherein performing a diagnostic assessment of one of the primary device includes obtaining one or more of device identifying information, device orientation sensor status, battery status, branding labeling information, location information, memory information, device local radio operation, display status, housing status; device power up status, and audio status.

67. The method of claim 66, wherein device orientation sensor status may include one or more of an operational status and a current value of a device's magnetometer, accelerometer, gyroscope, pressure sensor, or a sensor used by the device in obtaining its physical orientation.

68. The method of claim 66, wherein battery status may include one or more of information regarding whether a device's battery is charged; whether the battery is capable of holding a charge; an estimated capacity comparison to original specification of a battery; a battery maximum and/or minimum level, and a current charging type.

69. The method of claim 66, wherein location information may include one or more of locale indicators; GPS information; location data services information; connected wireless tower information; and visited Wi-Fi domains.

70. The method of claim 66, wherein memory information includes one or more of: an average memory usage of a device; a maximum and minimum memory usage of a device; storage capacity of a device; storage used by a device; internal memory/storage of a device; and external memory card status and/or capacity of a device.

71. The method of claim 66, wherein device local radio operation includes one or more of: operational status and information regarding whether a Wi-Fi connection is operational not, a device uptime figure, an amount of data sent or received through Wi-Fi; Bluetooth operational status; and NFC status.

72. The method of claim 66, wherein display status information includes one or more test results regarding whether: a screen of the mobile device is cracked or not; a location of a crack on a screen of a device; a size and extent of a crack on a display of a mobile device; a current brightness level of a display; an indicator whether an LCD is functioning.

73. The method of claim 66, wherein power up status includes one or more of whether a mobile device powers up in a predetermined period of time, and whether a power button of a mobile device is operational.

74. The method of claim 66, wherein audio status may include whether a volume up button or down button works within predetermined ranges; whether a speaker is outputting an audio signal at an expected volume level, whether a microphone is receiving audio inputs with acceptable gain, whether a microphone is receiving audio inputs at predetermined frequencies, and whether a speaker of the mobile device is producing audio signals at desired amplitudes at a range of frequencies.

75. The method of claim 56, further comprising: identifying one or more secondary devices not directly associated with the device owner, and presenting an incentive for the device owner to contact an owner of the one or more secondary devices not directly associated with the device owner to propose insurance or warranty coverage.

76. The method of claim 56, wherein the database record is at least partially stored in a database server managed by a third-party insurance or warranty provider, and where in the database server is communicatively coupled to the primary device.

77. The method of claim 56, further comprising dynamically adjusting a monthly premium amount based on usage profiles of the primary device.

78. The method of claim 77, wherein the usage profiles include parameters related to risk of loss, damage, or aging of any of the primary device or secondary devices.
